(19) United States
(12) Patent Application Publication
(10) Pub. No.: US 2019/0203801 A1
(43) Pub. Date: Jul. 4, 2019

(54) DAMPER DEVICE

(71) Applicants: AISIN AW INDUSTRIES CO., LTD, Echizen-shi, Fukui (JP); AISIN AW CO., LTD., Anjo-shi, Aichi (JP)

(72) Inventors: Takuya YOSHIKAWA, Echizen-shi (JP); Aki OGAWA, Echizen-shi (JP); Yoshihiro YOSHIDA, Echizen-shi (JP); Akiyoshi KATO, Echizen-shi (JP); Yoichi OI, Anjo-shi (JP); Masaki WAJIMA, Anjo-shi (JP)

(73) Assignees: AISIN AW INDUSTRIES CO., LTD, Echizen-shi, Fukui (JP); AISIN AW CO., LTD., Anjo-shi, Aichi (JP)

(21) Appl. No.: 16/331,380

(22) PCT Filed: Aug. 25, 2017
(86) PCT No.: PCT/JP2017/030511

§ 371 Date: Mar. 7, 2019

(30) Foreign Application Priority Data
Sep. 9, 2016 (JP) 2016-176670

(51) Int. Cl. F16F 15/134; F16F 15/14

(52) U.S. Cl. CPC F16F 15/13469; F16H 45/02; F16F 15/1478

(57) ABSTRACT

A rotating inertia mass damper of a damper device comprises a planetary gear including a driven member that has external teeth and that serves as a sun gear; a plurality of pinion gears; first and second input plate members that are configured to support the plurality of pinion gears in a rotatable manner and that serve as a carrier; and a ring gear that is engaged with the plurality of pinion gears and that serves as a mass body. The ring gear has two gear main bodies that are arranged along an axial direction of the planetary gear and that are coupled with each other. Internal teeth of the two gear main bodies are shifted to each other in a circumferential direction of the gear main bodies.

### TECHNICAL FIELD

The present disclosure relates to a damper device.

### BACKGROUND

A torque converter is conventionally known to include a lockup clutch, a torsional vibration damper, and a rotating inertia mass damper (transmission mechanism) having a planetary gear (as described in, for example, Patent Literature 1). The torsional vibration damper of this torque converter includes two cover plates (input element) that are coupled with a lockup piston via a plurality of bearing journals; a sun gear that is placed between the two cover plates in an axial direction and that serves as a driven-side transmission element (output element); and a spring (elastic body) that is configured to transmit a torque between the cover plate and the sun gear. The rotating inertia mass damper includes a plurality of pinion gears (planet gears) that are supported in a rotatable manner by the cover plates serving as a carrier via the bearing journals; and a ring gear that is engaged with the plurality of pinion gears, in addition to the sun gear. In the torque converter configured as described above, when the cover plate of the torsional vibration damper is rotated (twisted) relative to the sun gear in the state of engagement of the lockup clutch, the spring is deflected and the ring gear serving as a mass body is rotated with the relative rotation of the cover plate to the sun gear. This configuration causes an inertial torque corresponding to a difference between angular accelerations of the cover plate and the sun gear to be applied from the ring gear serving as the mass body via the pinion gear to the sun gear that is the output element of the torsional vibration damper and improves the vibration damping performance of the torsional vibration damper.

### CITATION LIST

### Patent Literature

Patent Literature 1: U.S. Pat. No. 3,299,510B

### SUMMARY

In the conventional rotating inertia mass damper described above, when there is a backlash between gear teeth of gears engaging with each other (the sun gear and the pinion gear or the pinion gear and the ring gear), the backlash between the gear teeth of the gears engaging with each other is eliminated during inversion of a torque input into the planetary gear. An idling state occurs during elimination of the backlash, and no inertial torque is output to the transmission element (output element) via the rotating inertia mass damper. It is accordingly difficult for the torque converter to effectively damp the vibration. The idling time required for elimination of the backlash between the gear teeth of the gears engaging with each other is expected to increase with an increase in the degree of backlash between the gear teeth.

A main object of the damper device of the present disclosure is to reduce a backlash between gear teeth of gears of a planetary gear engaging with each other in a rotating inertia mass damper and further improve the vibration damping performance of the damper device.

The present disclosure is directed to a damper device. A damper device includes a plurality of rotational elements including an input element which a torque from an engine is transmitted to and an output element, an elastic body configured to transmit a torque between the input element and the output element and a rotating inertia mass damper comprising a mass body and a planetary gear configured to rotate the mass body with relative rotation of a first rotational element that is one of the plurality of rotational elements to a second rotational element that is different from the first rotational element. The planetary gear includes a sun gear, a plurality of pinion gears configured to engage with the sun gear, a carrier configured to support the plurality of pinion gears in a rotatable manner and a ring gear configured to engage with the plurality of pinion gears. At least one of the sun gear, the pinion gear and the ring gear has two gear members that are arranged along an axial direction of the planetary gear and that are coupled with each other. Gear teeth of the two gear members are shifted to each other in a circumferential direction of the two gear members, such as to reduce a backlash between the gear teeth of the two gear members and gear teeth of a gear engaging with the two gear members.

The damper device of this aspect enables an antiresonance point where the vibration amplitude of the output element theoretically becomes equal to zero to be set. In the damper device of this aspect, at least one of the sun gear, the pinion gear and the ring gear of the planetary gear in the rotating inertia mass damper has the two gear members that are arranged along the axial direction of the planetary gear and that are coupled with each other. The gear teeth of the two gear members are shifted to each other in the circumferential direction of the two gear members, such as to reduce a backlash between the gear teeth of the two gear members and gear teeth of a gear engaging with the two gear members. This configuration accordingly reduces the backlash between the gear teeth of the two gear members and the gear teeth of the gear engaging with the two gear members in the planetary gear and further improves the vibration damping performance of the damper device.

### BRIEF DESCRIPTION OF DRAWINGS

FIG. 1 is a schematic configuration diagram illustrating a starting device including a damper device according to the present disclosure;

FIG. 2 is a sectional view illustrating the starting device of FIG. 1;

FIG. 3 is a front view illustrating the damper device according to the present disclosure;

FIG. 4 is a main part enlarged sectional view illustrating a rotating inertia mass damper included in the damper device of the present disclosure;

FIG. 5 is a front view illustrating a pinion gear and a gear main body of the rotating inertia mass damper;

FIG. 6 is a diagram illustrating relationships between a rotation speed of an engine EG and a torque fluctuation of an output element of the damper device of the present disclosure;

FIG. 7 is a diagram illustrating one example of time changes of torques Tsp, Td and Tsum when the rotation speed of the engine EG is equal to a rotation speed corresponding to either an antiresonance point A1 or an antiresonance point A2;

FIG. 8 is a diagram illustrating a relative velocity of a ring gear of the rotating inertia mass damper to a drive member of the damper device;

FIG. 9 is a diagram illustrating a relative velocity of the ring gear to the pinion gear of the rotating inertia mass damper;

FIG. 10 is a diagram illustrating a torque difference indicating a quantified hysteresis of the rotating inertia mass damper included in the damper device of the present disclosure;

FIG. 11 is a schematic configuration diagram illustrating a rotating mass damper according to a modification of the present disclosure;

FIG. 12 is a schematic configuration diagram illustrating a starting device including a damper device according to a modification of the present disclosure;

FIG. 13 is a schematic configuration diagram illustrating a starting device including a damper device according to another modification of the present disclosure; and

FIG. 14 is a schematic configuration diagram illustrating a starting device including a damper device according to another modification of the present disclosure.

### DESCRIPTION OF EMBODIMENTS

The following describes some aspects of the disclosure with reference to embodiments.

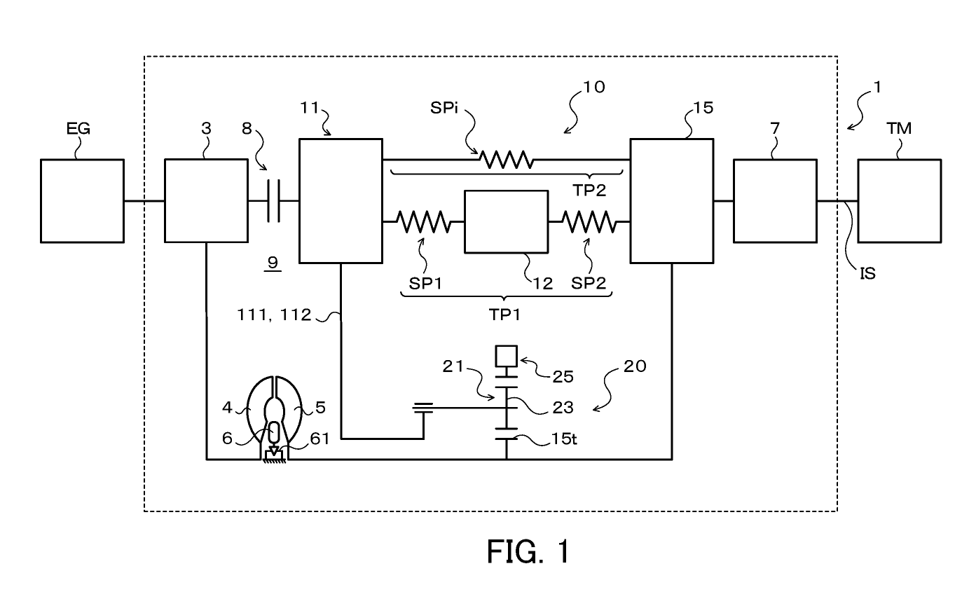

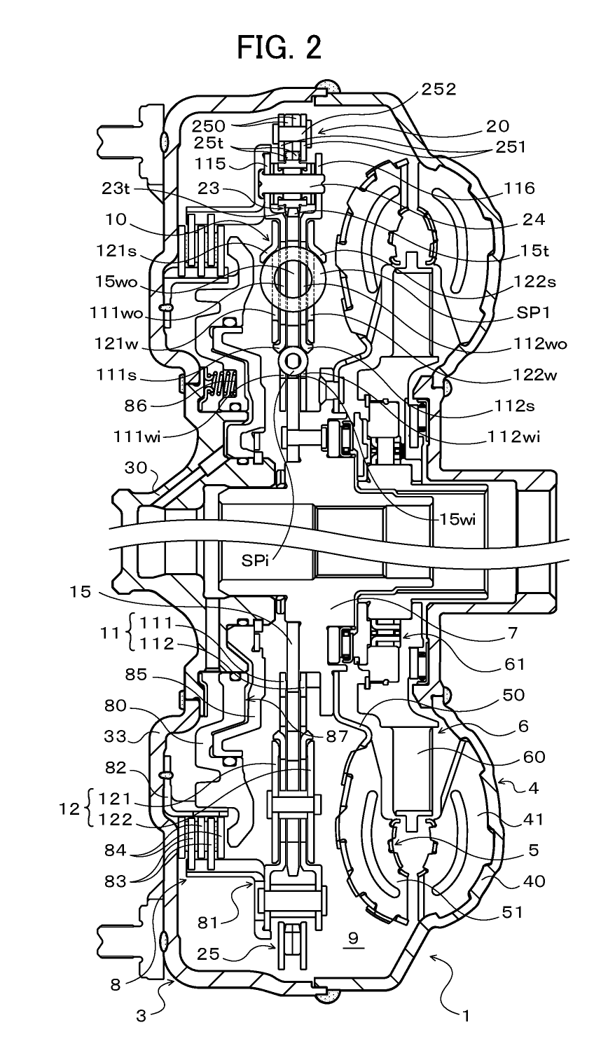

FIG. 1 is a schematic configuration diagram illustrating a starting device 1 including a damper device 10 of the present disclosure. FIG. 2 is a sectional view illustrating the starting device 1. The starting device 1 shown in these drawings is mounted on a vehicle equipped with an engine (internal combustion engine) EG as a driving device and includes, in addition to the damper device 10, for example, a front cover 3 as an input member coupled with a crankshaft of the engine EG to receive a torque transmitted from the engine EG; a pump impeller (input-side fluid transmission element) 4 fixed to the front cover 3; a turbine runner (output-side fluid transmission element) 5 configured to be rotatable coaxially with the pump impeller 4; a damper hub 7 as an output member coupled with the damper device 10 and fixed to an input shaft IS of a transmission TM, which is either an automatic transmission (AT) or a continuously variable transmission (CVT); and a lockup clutch 8.

In the description below, an “axial direction” basically denotes an extending direction of a center axis (axial center) of the starting device 1 or the damper device 10, unless otherwise specified. A “radial direction” basically denotes a radial direction of the starting device 1, the damper device 10 or a rotational element of the damper device 10 or the like or more specifically an extending direction of a straight line extended from the center axis of the starting device 1 or the damper device 10 in a direction perpendicular to the center axis (in a radial direction), unless otherwise specified. A “circumferential direction” basically denotes a circumferential direction of the starting device 1, the damper device 10 or the rotational element of the damper device 10 or the like, or, in other words, a direction along a rotating direction of the rotational element, unless otherwise specified.

As shown in FIG. 2, the pump impeller 4 includes a pump shell 40 closely fixed to the front cover 3 to define a fluid chamber 9 which hydraulic oil flows in; and a plurality of pump blades 41 placed on an inner surface of the pump shell 40. As shown in FIG. 2, the turbine runner 5 includes a turbine shell 50; and a plurality of turbine blades 51 placed on an inner surface of the turbine shell 50. An inner circumferential portion of the turbine shell 50 is fixed to the damper hub 7 by means of a plurality of rivets. The pump impeller 4 and the turbine runner 5 are opposed to each other, and a stator 6 is coaxially arranged between the pump impeller 4 and the turbine runner 5 to rectify the flow of the hydraulic oil (working fluid) from the turbine runner 5 to the pump impeller 4. The stator 6 includes a plurality of stator blades 60, and the rotating direction of the stator 6 is set to only one direction by a one-way clutch 61. The pump impeller 4, the turbine runner 5 and the stator 6 form a torus (annular flow path) to circulate the hydraulic oil and serves as a torque converter (fluid transmission device) having a torque amplification function. The stator 6 and the one-way clutch 61 may be omitted from the starting device 1, and the pump impeller 4 and the turbine runner 5 may serve as fluid coupling.

The lockup clutch 8 is configured as a hydraulic multiple disc clutch to establish and release lockup that couples the front cover 3 with the damper hub 7 via the damper device 10. The lockup clutch 8 includes a lockup piston 80 supported to be movable in the axial direction by a center piece 30 that is fixed to the front cover 3; a clutch drum 81; a ring-shaped clutch hub 82 fixed to an inner surface of a side wall portion 33 of the front cover 3 such as to be opposed to the lockup piston 80; a plurality of first frictional engagement plates (friction plates having friction materials on respective surfaces thereof) 83 fit in a spline formed in an inner circumference of the clutch drum 81; and a plurality of second frictional engagement plates 84 (separator plates) fit in a spline formed in an outer circumference of the clutch hub 82.

The lockup clutch 8 also includes a ring-shaped flange member (oil chamber-defining member) 85 mounted to the center piece 30 of the front cover 3 such as to be located on the opposite side to the front cover 3 relative to the lockup piston 80, i.e., to be located on the damper device 10-side and the turbine runner 5-side of the lockup piston 80; and a plurality of return springs 86 placed between the front cover 3 and the lockup piston 80. As illustrated, the lockup piston 80 and the flange member 85 define an engagement oil chamber 87, and hydraulic oil (engagement hydraulic pressure) is supplied from a non-illustrated hydraulic pressure controller to the engagement oil chamber 87. Increasing the engagement hydraulic pressure supplied to the engagement oil chamber 87 moves the lockup piston 80 in the axial direction to press the first frictional engagement plates 83 and the second frictional engagement plates 84 toward the front cover 3, so as to engage (fully engage or slip engage) the lockup clutch 8. The lockup clutch 8 may be configured as a hydraulic single disc clutch.

As shown in FIG. 1 and FIG. 2, the damper device 10 includes a drive member (input element) 11, an intermediate member (intermediate element) 12 and a driven member (output element) 15, as rotational elements. The damper device 10 also includes a plurality of (for example, three according to the embodiment) first springs (first elastic body) SP1 configured to transmit the torque between the drive member 11 and the intermediate member 12; a plurality of (for example, three according to the embodiment) second springs (second elastic body) SP2 configured to work respectively in series with the corresponding first springs SP1 and transmit the torque between the intermediate member 12 and the driven member 15; and a plurality of (for example, three according to the embodiment) inner springs SPi configured to transmit the torque between the drive member 11 and the driven member 15, as torque transmission elements (torque transmission elastic body).

More specifically, as shown in FIG. 1, the damper device 10 has a first torque transmission path TP1 and a second torque transmission path TP2 that are provided in parallel to each other between the drive member 11 and the driven member 15. The first torque transmission path TP1 is formed by the plurality of first springs SP1, the intermediate member 12 and the plurality of second springs SP2 and transmits the torque between the drive member 11 and the driven member 15 via these elements. According to the embodiment, coil springs having identical specifications (spring constants) are employed as the first springs SP1 and the second springs SP2 constituting the first torque transmission path TP1.

The second torque transmission path TP2 is formed by the plurality of inner springs SPi and transmits the torque between the drive member 11 and the driven member 15 via the plurality of inner springs SPi working in parallel to one another. According to the embodiment, the plurality of inner springs Spi forming the second torque transmission path TP2 work in parallel to the first springs SP1 and the second springs Sp2 constituting the first torque transmission path TP1, when an input torque into the drive member 11 reaches a predetermined torque (first reference value) T1 that is smaller than a torque T2 (second reference value) corresponding to a maximum flight angle θmax of the damper device 10 and a flight angle of the drive member 11 relative to the driven member 15 becomes equal to or larger than a predetermined angle θref. Accordingly, the damper device 10 has two-step (two-stage) damping characteristics.

According to the embodiment, linear coil springs formed from a metal material helically wound to have an axial center extended straight under no application of a load are employed as the first springs SP1, the second springs SP2 and the inner springs SPi. This configuration enables the first springs SP1, the second springs SP2 and the inner springs SPi to be more appropriately stretched and contracted along the axial center, compared with a configuration employing arc coil springs. As a result, this configuration reduces a hysteresis or more specifically a difference between a torque transmitted from the second springs SP2 and the like to the driven member 15 in the process of increasing a relative displacement between the drive member 11 (input element) and the driven member 15 (output element) and a torque transmitted from the second springs SP2 and the like to the driven member 15 in the process of decreasing the relative displacement between the drive member 11 and the driven member 15. Arc coil springs may be employed as at least any of the first springs SP1, the second springs SP2 and the inner springs SPi.

As shown in FIG. 2, the drive member 11 of the damper device 10 includes a ring-shaped first input plate member 111 that is coupled with the clutch drum 81 of the lockup clutch 8; and a ring-shaped second input plate member 112 that is coupled with the first input plate member 111 by means of a plurality of rivets such as to be opposed to the first input plate member 111. Accordingly, the drive member 11 or more specifically the first input plate member 111 and the second input plate member 112 rotate integrally with the clutch drum 81, and the front cover 3 (engine EG) and the drive member 11 of the damper device 10 are coupled with each other by engagement of the lockup clutch 8.

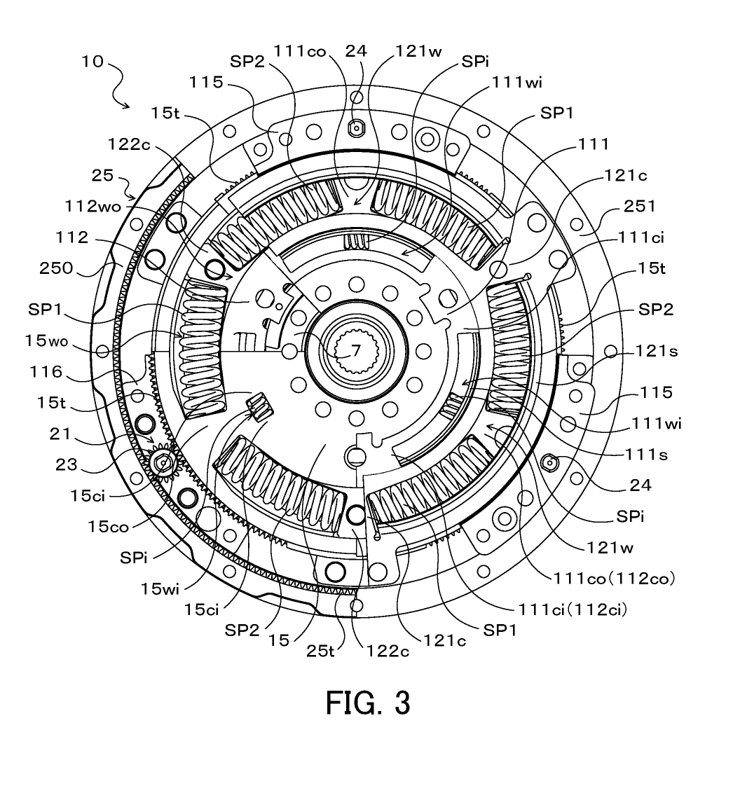

FIG. 3 is a front view illustrating the damper device 10 according to the present disclosure. As shown in FIG. 2 and FIG. 3, the first input plate member 111 includes a plurality of (for example, three according to the embodiment) outer spring placing windows 111wo that are respectively extended in an arc shape and that are placed at intervals (at equal intervals) in the circumferential direction; a plurality of (for example, three according to the embodiment) inner spring placing windows 111wi that are respectively extended in an arc shape and that are placed at intervals (at equal intervals) in the circumferential direction to be arranged on an inner side in the radial direction of the respective outer spring placing windows 111wo; a plurality of (for example, three according to the embodiment) spring support structures 111s that are extended along outer edges of the respective inner spring placing windows 111wi; a plurality of (for example, three according to the embodiment) outer spring abutting structures 111co; and a plurality of (for example, six according to the embodiment) inner spring abutting structures 111ci. The respective inner spring placing windows 111wi have a circumference longer than the natural length of the inner springs SPi (as shown in FIG. 3). Each of the outer spring abutting structures 111co is provided between adjacent outer spring placing windows 111wo that adjoin to each other along the circumferential direction. Additionally, the innerspring abutting structures 111ci are provided on respective sides in the circumferential direction of each of the inner spring placing windows 111wi.

The second input plate member 112 includes a plurality of (for example, three according to the embodiment) outer spring placing windows 112wo that are respectively extended in an arc shape and that are placed at intervals (at equal intervals) in the circumferential direction; a plurality of (for example, three according to the embodiment) inner spring placing windows 112wi that are respectively extended in an arc shape and that are placed at intervals (at equal intervals) in the circumferential direction to be arranged on an inner side in the radial direction of the respective outer spring placing windows 112wo; a plurality of (for example, three according to the embodiment) spring support structures 112s that are extended along outer edges of the respective inner spring placing windows 112wi; a plurality of (for example, three according to the embodiment) outer spring abutting structures 112co; and a plurality of (for example, six according to the embodiment) inner spring abutting structures 112ci. The respective inner spring placing windows 112wi have a circumference longer than the natural length of the inner springs SPi (as shown in FIG. 3). Each of the outer spring abutting structures 112co is provided between adjacent outer spring placing windows 112wo that adjoin to each other along the circumferential direction. Additionally, the inner spring abutting structures 112ci are provided on respective sides in the circumferential direction of each of the inner spring placing windows 112wi. According to the embodiment, components of an identical shape are employed as the first input plate member 111 and the second input plate member 112. This configuration reduces the number of different types of components.

The intermediate member 12 includes a ring-shaped first intermediate plate member 121 that is placed on the front cover 3-side of the first input plate member 111 of the drive member 11; and a ring-shaped second intermediate plate member 122 that is placed on the turbine runner 5-side of the second input plate member 112 of the drive member 11 and that is coupled with (fixed to) the first intermediate plate member 121 by means of a plurality of rivets. As shown in FIG. 2, the first intermediate plate member 121 and the second intermediate plate member 122 are arranged such that the first input plate member 111 and the second input plate member 112 are placed between the first and second intermediate plate members 121 and 122 in the axial direction of the damper device 10.

As shown in FIG. 2 and FIG. 3, the first intermediate plate member 121 includes a plurality of (for example, three according to the embodiment) spring placing windows 121w that are respectively extended in an arc shape and that are placed at intervals (at equal intervals) in the circumferential direction; a plurality of (for example, three according to the embodiment) spring support structures 121s that are extended along outer edges of the respective corresponding spring placing windows 121w; and a plurality of (for example, three according to the embodiment) spring abutting structures 121c. Each of the spring abutting structures 121c is provided between adjacent spring placing windows 121w that adjoin to each other along the circumferential direction. The second intermediate plate member 122 includes a plurality of (for example, three according to the embodiment) spring placing windows 122w that are respectively extended in an arc shape and that are placed at intervals (at equal intervals) in the circumferential direction; a plurality of (for example, three according to the embodiment) spring support structures 122s that are extended along outer edges of the respective corresponding spring placing windows 122w; and a plurality of (for example, three according to the embodiment) spring abutting structures 122c. Each of the spring abutting structures 122c is provided between adjacent spring placing windows 122w that adjoin to each other along the circumferential direction. According to the embodiment, components of an identical shape are employed as the first intermediate plate member 121 and the second intermediate plate member 122. This configuration reduces the number of different types of components.

The driven member 15 is configured as a plate-like ring-shaped member, is placed between the first input plate member 111 and the second input plate member 112 in the axial direction, and is fixed to the damper hub 7 by means of a plurality of rivets. As shown in FIG. 2 and FIG. 3, the driven member 15 includes a plurality of (for example, three according to the embodiment) outer spring placing windows 15wo that are respectively extended in an arc shape and that are placed at intervals (at equal intervals) in the circumferential direction; a plurality of (for example, three according to the embodiment) inner spring placing windows 15wi that are placed at intervals (at equal intervals) in the circumferential direction to be arranged on an inner side in the radial direction of the respective outer spring placing windows 15wo; a plurality of (for example, three according to the embodiment) outer spring abutting structures 15co; and a plurality of (for example, six according to the embodiment) inner spring abutting structures 15ci. Each of the outer spring abutting structures 15co is provided between adjacent outer spring placing windows 15wo that adjoin to each other along the circumferential direction. The respective inner spring placing windows 15wi have a circumference corresponding to the natural length of the inner springs SPi. Additionally, the inner spring abutting structures 15ci are provided on respective sides in the circumferential direction of each of the inner spring placing windows 15wi.

One first spring SP1 and one second spring SP2 are arranged to be paired (i.e., to work in series) in the outer spring placing windows 111wo of the first input plate member 111, the outer spring placing windows 112wo of the second input plate member 112, and the outer spring placing windows 15wo of the driven member 15. In the mounted state of the damper device 10, each of the outer spring abutting structures 111co and 112co of the first and the second input plate members 111 and 112 and the outer spring abutting structures 15co of the driven member 15 is located between the first spring SP1 and the second spring SP2 that are placed in different outer spring placing windows 15wo, 111wo and 112wo not to be paired (i.e., not to work in series) and is arranged to abut on ends of the first spring SP1 and the second spring SP2.

Furthermore, each of the spring abutting structures 121c and 122c of the first and the second intermedia plate members 121 and 122 is placed between the first spring SP1 and the second spring SP2 that are placed in identical outer spring placing windows 15wo, 111wo and 112wo to be paired and is arranged to abut on ends of the first spring SP1 and the second spring SP2. The first spring SP1 and the second spring SP2 that are placed indifferent outer spring placing windows 15wo, 111wo and 112wo and that are not paired (i.e., not to work in series) are placed in the spring placing windows 121w and 122w of the first and the second intermediate plate members 121 and 122. Additionally, the first spring SP1 and the second spring SP2 that are not paired (i.e., not to work in series) are supported (guided) from outer side in the radial direction by the spring support structures 121s of the first intermediate plate member 121 on the front cover 3-side and are also supported (guided) from outer side in the radial direction by the spring support structures 122s of the second intermediate plate member 122 on the turbine runner 5-side.

As shown in FIG. 3, the first springs SP1 and the second springs SP2 are thus arranged alternately in the circumferential direction of the damper device 10. One end of each of the first springs SP1 abuts on the corresponding outer spring abutting structures 111co and 112co of the drive member 11, and the other end of each of the first springs SP1 abuts on the corresponding spring abutting structures 121c and 122c of the intermediate member 12. One end of each of the second springs SP2 abuts on the corresponding spring abutting structures 121c and 122c of the intermediate member 12, and the other end of each of the second springs SP2 abuts on the corresponding outer spring abutting structure 15co of the driven member 15.

As a result, the first spring SP1 and the second spring SP2 that are paired are coupled in series via the corresponding spring abutting structures 121c and 122c of the intermediate member 12 between the drive member 11 and the driven member 15. In the damper device 10, this configuration reduces the stiffness of the elastic body serving to transmit the torque between the drive member 11 and the driven member 15, i.e., reduces a combined spring constant of the first and the second springs SP1 and SP2. According to the embodiment, as shown in FIG. 3, the plurality of first springs SP1 and the plurality of second springs PS2 are respectively arranged on an identical circumference, such that the distances between the axial center of the starting device 1 or the damper device 10 and the axial centers of the respective first springs SP1 and the distances between the axial center of the starting device 1 or the like and the axial centers of the respective second springs SP2 are equal to each other.

The inner spring SPi is placed in each of the inner spring placing windows 15wi of the driven member 15. In the mounted state of the damper device 10, each of the inner spring abutting structures 15ci abuts on a corresponding end of the inner spring SPi. Additionally, in the mounted state of the damper device 10, a front cover 3-side lateral portion of each of the inner springs SPi is placed in a center part in the circumferential direction of the corresponding inner spring placing window 111wi of the first input plate member 111 and is supported (guided) from outside in the radial direction by the spring support structure 111s of the first input plate member 111. In the mounted state of the damper device 10, a turbine runner 5-side lateral portion of each of the inner springs SPi is placed in a center part in the circumferential direction of the corresponding inner spring placing window 112wi of the second input plate member 112 and is supported (guided) from outside in the radial direction by the spring support structure 112s of the second input plate member 112.

As shown in FIG. 2 and FIG. 3, each of the inner springs SPi is accordingly placed in an inner circumferential region in the fluid chamber 9 and is supported by the first spring SP1 and the second spring SP2. As a result, this configuration further shortens the axial length of the damper device 10 and thereby the axial length of the starting device 1. Each of the inner springs SPi abuts on one of the inner spring abutting structures 111ci and 112ci provided on respective sides of the corresponding inner spring placing windows 111wi and 112wi of the first and the second input plate members 111 and 112, when the input torque (drive torque) into the drive member 11 or the torque (driven torque) applied from the axle side to the driven member 15 reaches the torque T1.

The damper device 10 further includes a non-illustrated stopper configured to restrict the relative rotation of the drive member 11 to the driven member 15. According to the embodiment, the stopper includes a plurality of stopper bodies protruded in the radial direction from the inner circumferential portion of the second input plate member 112 toward the damper hub 7 and arranged at intervals in the circumferential direction; and a plurality of cuts formed in the damper hub 7 which the driven member 15 is fixed to, arranged at intervals in the circumferential direction and extended in an arc shape. In the mounted state of the damper device 10, each of the stopper bodies of the second input plate member is placed in the corresponding cut of the damper hub 7 such as not to abut on the wall surfaces of the damper hub 7 that define ends on the respective sides of the cut. When the stopper body of the second input plate member 112 abuts on one of the wall surfaces defining the ends on the respective sides of the cut of the damper hub 7 accompanied with relative rotation of the drive member 11 to the driven member 15, this configuration restricts the relative rotation of the drive member 11 and the driven member 15 and deflections of all the first and the second springs SP1 and SP2 and the inner springs SPi.

As shown in FIG. 1, the damper device 10 additionally includes a rotating inertia mass damper 20 that is arranged parallel to both the first torque transmission path TP1 including the plurality of first springs SP1, the intermediate member 12 and the plurality of second springs SP2 and the second torque transmission path TP2 including the plurality of inner springs SPi. According to the embodiment, the rotating inertia mass damper 20 includes a single pinion-type planetary gear 21 that is placed between the drive member 11 as the input element of the damper device 10 and the driven member 15 as the output element.

According to the embodiment, the planetary gear 21 is comprised of the driven member 15 that has external teeth (gear teeth) 15t on its outer circumference and that serves as a sun gear; a plurality of (for example, three according to the embodiment) pinion gears 23 that respectively engage with the external teeth 15t; the first and the second input plate members 111 and 112 that rotatably support the plurality of pinion gear 23 and that serve as a carrier; and a ring gear 25 that has internal teeth (gear teeth) 25t engaging with the respective pinion gears 23 and that is arranged concentrically with the driven member 15 (external teeth 15t) as the sun gear. Accordingly, the driven member 15 as the sun gear, the plurality of pinion gears 23, and the ring gear 25 at least partly overlap with the first and the second springs SP1 and SP2 (and the inner springs SPi) in the fluid chamber 9 in the axial direction when being viewed in the radial direction of the damper device 10.

As shown in FIG. 2 and FIG. 3, the external teeth 15t are formed at a plurality of locations determined at intervals (at equal intervals) in the circumferential direction in an outer circumferential surface of the driven member 15. Accordingly, the external teeth 15t are located on the outer side in the radial direction of the first springs SP1, the second springs SP2 and the inner springs SPi serving to transmit the torque between the drive member 11 and the driven member 15. The external teeth 15t may be formed around the entire outer circumference of the driven member 15.

As shown in FIG. 2 and FIG. 3, the first input plate member 111 constituting the carrier of the planetary gear 21 includes a plurality of (for example, three according to the embodiment) pinion gear support structures 115 that are arranged at intervals (at equal intervals) in the circumferential direction on the outer side in the radial direction of the outer spring abutting structures 111co. Similarly, as shown in FIG. 2 and FIG. 3, the second input plate member 112 constituting the carrier of the planetary gear 21 includes a plurality of (for example, three according to the embodiment) pinion gear support structures 116 that are arranged at intervals (at equal intervals) in the circumferential direction on the outer side in the radial direction of the outer spring abutting structures 112co.

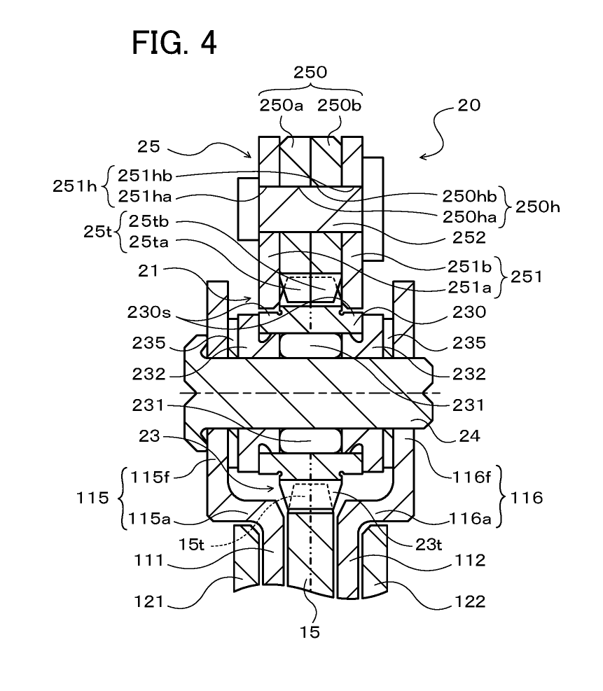

FIG. 4 is a main part enlarged sectional view illustrating a rotating inertia mass damper 20 included in the damper device 10 of the present disclosure. As shown in FIG. 4, each of the pinion gear support structures 115 of the first input plate member 111 includes an arc-shaped axially extended portion 115a that is formed to be protruded in the axial direction toward the front cover 3, and an arc-shaped flange portion 115f that is extended outward in the radial direction from an end of the axially extended portion 115a. Each of the pinion gear support structures 116 of the second input plate member 112 includes an arc-shaped axially extended portion 116a that is formed to be protruded in the axial direction toward the turbine runner 5, and an arc-shaped flange portion 116f that is extended outward in the radial direction from an end of the axially extended portion 116a. Each of the pinion gear support structures 115 (flange portions 115f) of the first input plate member 111 is opposed in the axial direction to the corresponding pinion gear support structure 116 (flange portion 116f) of the second input plate member 112, and the paired flange portions 115f and 116f support an end of a pinion shaft 24 inserted in the pinion gear 23. According to the embodiment, the pinion gear support structures 115 (flange portions 115f) of the first input plate member 111 are respectively clamped to the clutch drum 81 of the lockup clutch 8 by means of rivets. Furthermore, according to the embodiment, the first intermediate plate member 121 constituting the intermediate member 12 is aligned by inner circumferential surfaces of the axially extended portions 115a of the pinion gear support structures 115. The second intermediate plate member 122 constituting the intermediate member 12 is aligned by inner circumferential surfaces of the axially extended portions 116a of the pinion gear support structures 116.

As shown in FIG. 4, the pinion gear 23 of the planetary gear 21 includes a ring-shaped gear main body 230 that has gear teeth (external teeth) 23t on its outer circumference; a plurality of needle bearings 231 that are placed between an inner circumferential surface of the gear main body 230 and an outer circumferential surface of the pinion shaft 24; and a pair of spacers 232 that are fit on respective ends of the gear main body 230 to restrict the movements of the needle bearings 231 in the axial direction. As shown in FIG. 4, the gear main body 230 of the pinion gear 23 includes ring-shaped radial direction support structures 230s that are protruded on respective sides in the axial direction of the gear teeth 23t on the inner circumferential side of bottoms of the gear teeth 23t in the radial direction of the pinion gear 23 and that have outer circumferential surfaces in a cylindrical shape. The outer circumferential surface of each spacer 232 is formed to have a diameter that is equal to the diameter of the radial direction support structure 230s or that is smaller than the diameter of the radial direction support structure 230s.

The plurality of pinion gears 23 are rotatably supported by the first and the second input plate members 111 and 112 (pinion gear support structures 115 and 116) serving as the carrier to be arrayed at intervals (at equal intervals) in the circumferential direction. Washers 235 are placed between side surfaces of the respective spacers 232 and the pinion gear support structures 115 and 116 (flange portions 115f and 116f) of the first and second input plate members 111 and 112. Gaps are formed between respective side surfaces of the gear teeth 23t of the pinion gears 23 and the pinion gear support structures 115 and 116 (flange portions 115f and 116f) of the first and second input plate members 111 and 112 in the axial direction, as shown in FIG. 4.

The ring gear 25 of the planetary gear 21 has two gear main bodies 250 (250a, 250b) as ring-shaped two gear members that respectively have internal teeth (gear teeth) 25t (25ta, 25tb) formed on their inner circumferences and that are arranged along the axial direction of the planetary gear 21; two side plates 251 (251a, 251b) as two inertia members that are respectively formed in an annular shape; and a plurality of rivets 252 as a plurality of linkage members that are provided to fix the two side plates 251a and 251b from respective sides in the axial direction of the two gear main bodies 250a and 250b. The two gear main bodies 250a and 250b, the two side plates 251a and 251b and the plurality of rivets 252 are integrated to serve as a mass body of the rotating inertia mass damper 20. According to the embodiment, the internal teeth 25ta and 25tb are formed around the entire inner circumferential surfaces of the two gear main bodies 250a and 250b. The internal teeth 25ta and 25tb may be formed at a plurality of locations determined at intervals (at equal intervals) in the circumferential direction in the inner circumferential surfaces of the two gear main bodies 250a and 250b. As shown in FIG. 3, a plurality of recesses serving to adjust the mass of the ring gear 25 may be formed in the outer circumferential surfaces of the two gear main bodies 250a and 250b and may be arranged at intervals (at equal intervals) in the circumferential direction.

As shown in FIG. 4, the two gear main bodies 250 (250a, 250b) have elliptical connection holes 250h (250ha, 250hb) with their longitudinal sides in the circumferential direction, and the two side plates 251 (251a, 251b) have connection holes 251h (251ha, 251hb). The connection holes 250ha and 250hb of the two gear main bodies 250a and 250b may be elongated holes. The two gear main bodies 250a and 250b and the two side plates 251a and 251b are arranged in the sequence of the side plate 251a, the gear main body 250a, the gear main body 250b and the side plate 251b from the left side in FIG. 4. The two gear main bodies 250a and 250b and the two side plates 251a and 251b are coupled with one another such that the internal teeth 25ta and 25tb of the two gear main bodies 250a and 250b are displaced from each other in the circumferential direction of the gear main bodies 250a and 250b via the rivets 252 inserted through the connection holes 251ha, 250ha, 250hb and 251hb.

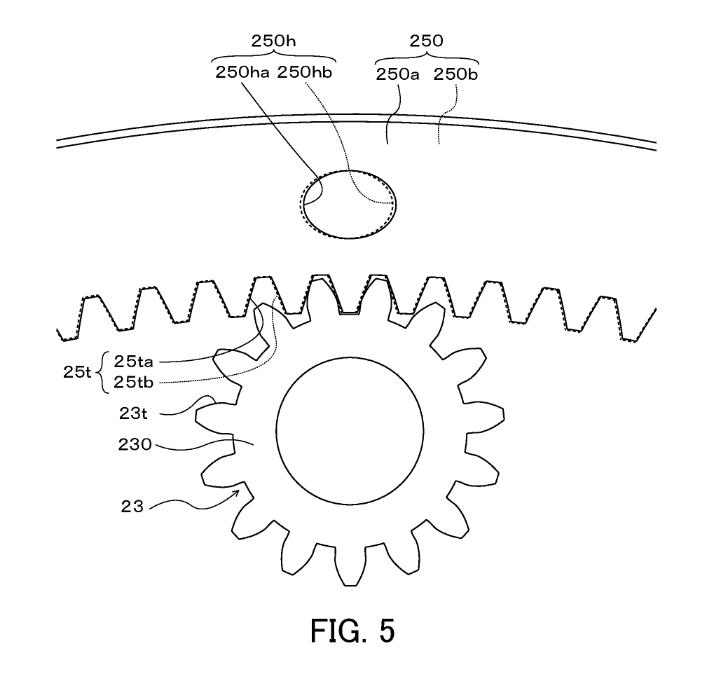

FIG. 5 is a front view illustrating a pinion gear 23 and a gear main body 250 of the rotating inertia mass damper 20. For the enhanced visibility, the gear main body 250b is shown by the dotted line in FIG. 5. For example, the displacement of the internal teeth 25ta and 25tb of the two gear main bodies 250a and 250b may be adjusted (set) as described below. From the state that the rivets 252 are inserted through the connection holes 251ha, 250ha, 250hb and 251hb of the side plate 251a, the gear main bodies 250a and 250b and the side plate 251b and that the angle of the displacement between the internal teeth 25ta and the internal teeth 25tb is zero, at least one of the gear main bodies 250a and 250b is rotated around the axial center to provide a displacement between the internal teeth 25ta and the internal teeth 25tb, such as to eliminate a backlash between the internal teeth 25ta and 25tb and the pinion gear 23 (provide zero backlash). The angle of the displacement between the internal teeth 25ta and the internal teeth 25tb in this state is defined as an angle θa. One of the gear main bodies 250a and 250b is then rotated around the axial center by a predetermined angle θb, such that the angle of the displacement between the internal teeth 25ta and the internal teeth 25tb becomes larger than zero but smaller than the angle θa. Accordingly, the angle of the displacement between the internal teeth 25ta and the internal teeth 25tb of the two gear main bodies 250a and 250b is given as a value (θ-θb). The backlash between the internal teeth 25ta and 25tb of the two gear main bodies 250a and 250b and the gear teeth 23t of the gear main body 230 of the pinion gear 23 has a length corresponding to the predetermined angle θb. The predetermined angle θb is determined to be minimized in a range where the ring gear 25 and the pinion gear 23 are smoothly rotatable. Ends of the rivets 252 are then swaged. This configuration reduces the backlash between the internal teeth 25ta and 25tb of the two gear main bodies 250a and 250b of the ring gear 25 and the gear teeth 23t of the gear main body 230 of the pinion gear 23, compared with a configuration that the ring gear 25 has only one gear main body (equivalent to a configuration that the angle of the displacement between the internal teeth 25ta and the internal teeth 25tb of the gear main bodies 250a and 250b is equal to zero). More specifically, even when the internal teeth 25t (25ta, 25tb) are formed with an equivalent tooth profile-forming accuracy to the conventional accuracy, the backlash between the internal teeth 25ta and 25tb and the gear teeth 23t can be reduced by displacing the internal teeth 25ta and the internal teeth 25tb from each other in the circumferential direction. Additionally, the two gear main bodies 250a and 250b have the elliptical (or elongated) connection holes 250ha and 250hb with their longitudinal sides in the circumferential direction. The internal teeth 25ta and the internal teeth 25tb can thus be displaced from each other in the circumferential direction by rotating the two gear main bodies 250a and 250b around the axial center after insertion of the rivets 252 through the connection holes 250ha and 250hb.

The two side plates 251a and 251b have inner circumferential surfaces of a recessed cylindrical shape and serve as supported portions that are supported in the axial direction by the plurality of pinion gears 23 that have the gear teeth 23t of the gear main body 230 engaging with the internal teeth 25ta and 25tb of the two gear main bodies 250a and 250b. More specifically, the two side plates 251a and 251b are fixed to corresponding side surfaces of the gear main bodies 250a and 250b on the respective sides in the axial direction of the internal teeth 25ta and 25tb such as to be protruded to the inner side in the radial direction of the bottoms of the internal teeth 25ta and 25tb and to be opposed to at least the side surfaces of the gear teeth 23t of the gear main body 230 of the pinion gear 23. According to the embodiment, inner circumferential surfaces of the two side plates 251a and 251b are located on the slightly inner side in the radial direction of tips of the internal teeth 25ta and 25tb as shown in FIG. 4.

When the gear teeth 23t of the gear main bodies 230 of the respective pinion gears 23 are engaged with the internal teeth 25ta and 25tb of the two gear main bodies 250a and 250b, the inner circumferential surfaces of the two side plates 251a and 251b are supported in the radial direction by the corresponding radial direction support structures 230s of the pinion gears 23 (gear main bodies 230). This configuration enables the ring gear 25 to be aligned with high accuracy relative to the axial center of the driven member 15 serving as the sun gear by the radial direction support structures 230s of the plurality of pinion gears 23 and smoothly rotates (swings) the ring gear 25. When the gear teeth 23t of the gear main bodies 230 of the respective pinion gears 23 are engaged with the internal teeth 25ta and 25tb of the two gear main bodies 250a and 250b, the inner surfaces of the two side plates 251a and 251b are opposed to side surfaces of the gear teeth 23t of the pinion gears 23 and side surfaces of portions from the bottoms of the gear teeth 23t to the radial direction support structures 230s. The movement in the axial direction of the ring gear 25 is accordingly restricted by at least the side surfaces of the gear teeth 23t of the pinion gear 23. Additionally, gaps are formed between outer surfaces of the two side plates 251a and 251b of the ring gear 25 and the pinion gear support structures 115 and 116 (flange portions 115f and 116f) of the first and second input plate members 111 and 112 in the axial direction, as shown in FIG. 4.

In the starting device 1 configured as described above, as understood from FIG. 1, in the state that the lockup by the lockup clutch 8 is released, the torque (power) transmitted from the engine EG to the front cover 3 is transmitted to the input shaft IS of the transmission TM through the path of the pump impeller 4, the turbine runner 5, the driven member 15 and the damper hub 7. In the state that the lockup is established by the lockup clutch 8 of the starting device 1, on the other hand, the torque transmitted from the engine EG to the drive member 11 through the front cover 3 and the lockup clutch 8 is transmitted to the driven member 15 and the damper hub 7 via the first torque transmission path TP1 including the plurality of first springs SP1, the intermediate member 12 and the plurality of second springs SP2 and the rotating inertia mass damper 20, until the input torque reaches the torque T1 described above. When the input torque becomes equal to or larger than the torque T1 described above, the torque transmitted to the drive member 11 is transmitted to the driven member 15 and the damper hub 7 via the first torque transmission path TP1, the second torque transmission path TP2 including the plurality of inner springs SPi, and the rotating inertia mass damper 20.

When the drive member 11 is rotated (twisted) relative to the driven member 15 in the established state of the lockup (in the engaged state of the lockup clutch 8), the first springs SP1 and the second springs SP2 are deflected, and the ring gear 25 as the mass body rotates (swings) around the axial center accompanied with the relative rotation of the drive member 11 to the driven member 15. When the drive member 11 is rotated (swung) relative to the driven member 15, the rotation speed of the drive member 11 or more specifically the first and the second input plate members 111 and 112 as the carrier that is the input element of the planetary gear 21 becomes higher than the rotation speed of the driven member 15 as the sun gear. Accordingly, in this state, the ring gear 25 is accelerated by the function of the planetary gear 21 to be rotated at the higher rotation speed than that of the drive member 11. An inertia torque is then applied from the ring gear 25 that is the mass body of the rotating inertia mass damper 20 to the driven member 15 that is the output element of the damper device 10 via the pinion gears 23. This damps the vibration of the driven member 15.

The following describes a procedure of designing the damper device 10.

As described above, in the damper device 10, the first and the second springs SP1 and SP2 included in the first torque transmission path TP1 and the rotating inertia mass damper 20 work in parallel until the input torque transmitted to the drive member 11 reaches the torque T1 described above. While the first and the second springs SP1 and SP2 and the rotating inertia mass damper 20 work in parallel, the torque transmitted from the first torque transmission path TP1 including the intermediate member 12 and the first and the second springs SP1 and SP2 to the driven member 15 is dependent on (proportional to) the displacement (amount of deflection, i.e., flight angle) of the second springs SP2 placed between the intermediate member 12 and the driven member 15. The torque transmitted from the rotating inertia mass damper 20 to the driven member 15 is, on the other hand, dependent on (proportional to) a difference in angular acceleration between the drive member 11 and the driven member 15, i.e., a twice differentiated value of the displacement of the first and the second springs SP1 and SP2 between the drive member 11 and the driven member 15. On the assumption that the input torque transmitted to the drive member 11 of the damper device 10 periodically vibrates as expressed by Expression (1) given below, the phase of the vibration transmitted from the drive member 11 to the driven member 15 via the first torque transmission path TP1 shifts by 180 degrees from the phase of the vibration transmitted from the drive member 11 to the driven member 15 via the rotating inertia mass damper 20.

[Math. 1]

T=T₀ sin ωt (1)

In the damper device 10 including the single intermediate member 12, two resonances occur in the first torque transmission path TP1 in the state that the deflection of the first and the second springs SP1 and SP2 is allowed and the inner springs SPi are not deflected. More specifically, resonance of the entire damper device 10 (first resonance) occurs in the first torque transmission path TP1 due to vibrations of the drive member 11 and the driven member 15 in the opposite phases in the state that the deflection of the first and the second springs SP1 and SP2 is allowed and the inner springs SPi are not deflected. Resonance (second resonance) also occurs in the first torque transmission path TP1 basically at the higher rotation speed (higher frequency) than the first resonance due to vibration of the intermediate member 12 in the opposite phase to the phases of both the drive member 11 and the driven member 15 in the state that the deflection of the first and the second springs SP1 and SP2 is allowed and the inner springs SPi are not deflected.

The inventors have performed intensive studies and analyses for the purpose of further improving the vibration damping effect of the damper device 10 having the above characteristics and have noted that the vibration of the driven member 15 can be damped by making the amplitude of the vibration in the first torque transmission path TP1 equal to the amplitude of the vibration of the opposite phase in the rotating inertia mass damper 20. The inventors have then established an equation of motion given as Expression (2) below with regard to a vibration system including the damper device 10 in the state that a torque is transmitted from the engine EG to the drive member 11 by establishment of the lockup and that the inner springs SPi are not deflected. In Expression (2), “J1” denotes the moment of inertia of the drive member 11; “J2” denotes the moment of inertia of the intermediate member 12 as described above; “J3” denotes the moment of inertia of the driven member 15; and “Ji” denotes the moment of inertia of the ring gear 25 that is the mass body of the rotating inertia mass damper 20. Furthermore, “θ1” denotes the flight angle of the drive member 11; “θ2” denotes the flight angle of the intermediate member 12; and “θ3” denotes the flight angle of the driven member 15. Additionally, “k1” denotes a combined spring constant of the plurality of first springs SP1 working in parallel between the drive member 11 and the intermediate member 12; and “k2” denotes a combined spring constant of the plurality of second springs SP2 working in parallel between the intermediate member 12 and the driven member 15. Furthermore, “λ” denotes the gear ratio (pitch circle diameter of the external teeth 15t (sun gear)/pitch circle diameter of the internal teeth 25t of the ring gear 25) of the planetary gear 21 constituting the rotating inertia mass damper 20, i.e., the ratio of the rotation speed of the ring gear 25 as the mass body to the rotation speed of the driven member 15; and “T1” denotes an input torque transmitted from the engine EG to the drive member 11.

$$\begin{matrix} [ Math . 2 ] & \\ [ \begin{matrix}{J}_{1} + {J}_{1} \cdot {( 1 + λ )}^{2} & 0 & - {J}_{i} \cdot λ \cdot ( 1 + λ ) \\ 0 & {J}_{2} & 0 \\ - {J}_{i} \cdot λ \cdot ( 1 + λ ) & 0 & {J}_{3} + {J}_{i} \cdot {λ}^{2}\end{matrix} ] [ \begin{matrix}{\ddot{θ}}_{1} \\ {\ddot{θ}}_{2} \\ {\ddot{θ}}_{3}\end{matrix} ] + [ \begin{matrix}{k}_{1} & - {k}_{1} & 0 \\ - {k}_{1} & {k}_{1} + {k}_{2} & - {k}_{2} \\ 0 & - {k}_{2} & {k}_{2}\end{matrix} ] [ \begin{matrix}{θ}_{1} \\ {θ}_{2} \\ {θ}_{3}\end{matrix} ] = [ \begin{matrix}{T}_{1} \\ 0 \\ 0\end{matrix} ] & ( 2 )\end{matrix}$$

Furthermore, the inventors have assumed that the input torque T periodically vibrates as expressed by Expression (1) given above and that the flight angle θ1 of the drive member 11, the flight angle θ2 of the intermediate member 12 and the flight angle θ3 of the driven member 15 periodically respond (vibrate) as expressed by Expression (3) given below. In Expression (1) and Expression (3), “ω” denotes an angular frequency in the periodical fluctuation (vibration) of the input torque T. In Expression (3), “Θ1” denotes the amplitude of the vibration (vibration amplitude, i.e., maximum flight angle) of the drive member 11 generated by transmission of the torque from the engine EG; “Θ2” denotes the amplitude of the vibration (vibration amplitude) of the intermediate member 12 generated by transmission of the torque from the engine EG to the drive member 11; and “Θ3” denotes the amplitude of the vibration (vibration amplitude) of the driven member 15 generated by transmission of the torque from the engine EG to the drive member 11. An identity given as Expression (4) below is obtained by substituting Expressions (1) and (3) into Expression (2) and eliminating “sin ωt” from both sides on the above assumption.

$$\begin{matrix} [ Math . 3 ] & \\ [ \begin{matrix}{θ}_{1} \\ {θ}_{2} \\ {θ}_{3}\end{matrix} ] = [ \begin{matrix}{Θ}_{1} \\ {Θ}_{2} \\ {Θ}_{3}\end{matrix} ] sin ω t & ( 3 ) \\ [ \begin{matrix}{T}_{1} \\ 0 \\ 0\end{matrix} ] = [ \begin{matrix}{k}_{1} - {ω}^{2} \{ {J}_{1} + {J}_{i} \cdot {( 1 + λ )}^{2} \} & - {k}_{1} & {ω}^{2} \cdot {J}_{i} \cdot λ \cdot ( 1 + λ ) \\ - {k}_{1} & {k}_{1} + {k}_{2} - {ω}^{2} \cdot {J}_{2} & - {k}_{2} \\ {ω}^{2} \cdot {J}_{i} \cdot λ \cdot ( 1 + λ ) & - {k}_{2} & {k}_{2} - {ω}^{2} ( {J}_{3} + {J}_{i} \cdot {λ}^{2} )\end{matrix} ] [ \begin{matrix}{Θ}_{1} \\ {Θ}_{2} \\ {Θ}_{3}\end{matrix} ] & ( 4 )\end{matrix}$$

In Expression (4), when the vibration amplitude Θ3 of the driven member 15 is equal to 0, the damper device 10 theoretically fully damps the vibration from the engine EG and theoretically causes no vibration to be transmitted to the transmission TM, the driveshaft and the like subsequent to the driven member 15. Accordingly, from this point of view, the inventors have obtained a conditional expression given by Expression (5) below when the identity of Expression (4) is solved with regard to the vibration amplitude Θ3 and the vibration amplitude Θ3 is set equal to 0. Expression (5) is a quadratic equation with regard to a square value of angular frequency ω2 in the periodic fluctuation of the input torque T. When the square value of angular frequency ω2 is one of two real roots (or a multiple root) of Expression (5), the vibration of the engine EG transmitted from the drive member 11 to the driven member 15 via the first torque transmission path TP1 and the vibration transmitted from the drive member 11 to the driven member 15 via the rotating inertia mass damper 20 are cancelled out each other, so that the vibration amplitude Θ3 of the driven member 15 theoretically becomes equal to zero.

[Math. 4]

J₂·J₁·λ(1+λ)·(ω²)²−J₁·λ(1+λ)·(k₁+k₂)·ω²+k₁·k₂=0 (5)

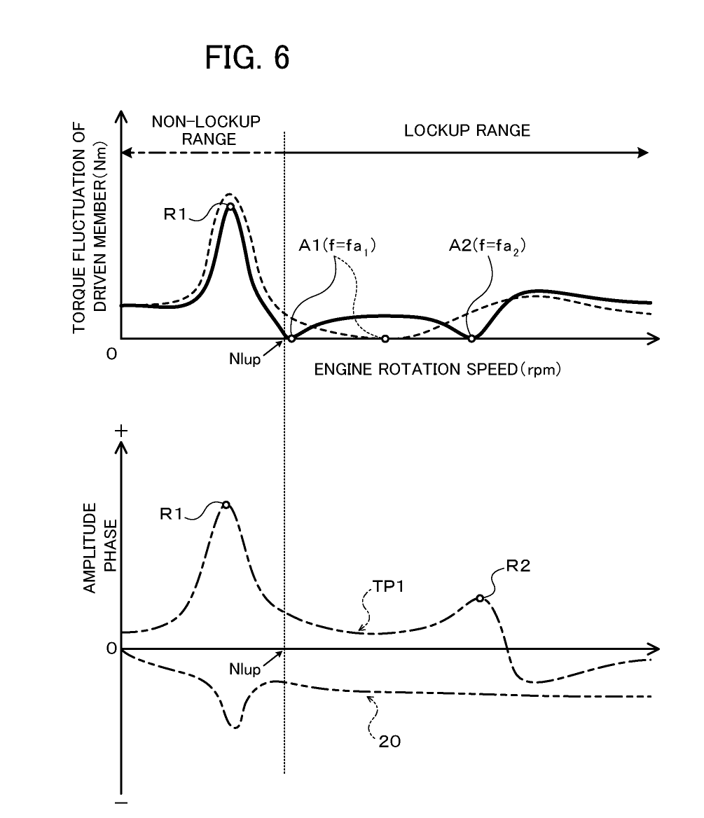

The results of such analyses show that a total of two antiresonance points (A1 and A2 in FIG. 6) where the vibration amplitude Θ3 of the driven member 15 theoretically becomes equal to zero may be set as shown in FIG. 6 in the damper device 10 including the intermediate member 12 to provide two peaks, i.e., resonances in the torque transmitted via the first torque transmission path TP1. Accordingly, the damper device 10 extremely effectively damps the vibration of the driven member 15 by making the amplitude of the vibration in the first torque transmission path TP1 and the amplitude of the vibration in the opposite phase in the rotating inertia mass damper 20 equal to each other at two points corresponding to two resonances occurring in the first torque transmission path TP1.

The above damper device 10 is configured to displace the internal teeth 25t (25ta and 25tb) of the two gear main bodies 250 (250a and 250b) of the ring gear 25 from each other in the circumferential direction of the gear main bodies 250. This configuration reduces the backlash between the internal teeth 25ta and 25tb of the two gear main bodies 250a and 250b of the ring gear 25 and the gear teeth 23t of the gear main body 230 of the pinion gear 23, compared with the configuration that the ring gear 25 has only one gear main body

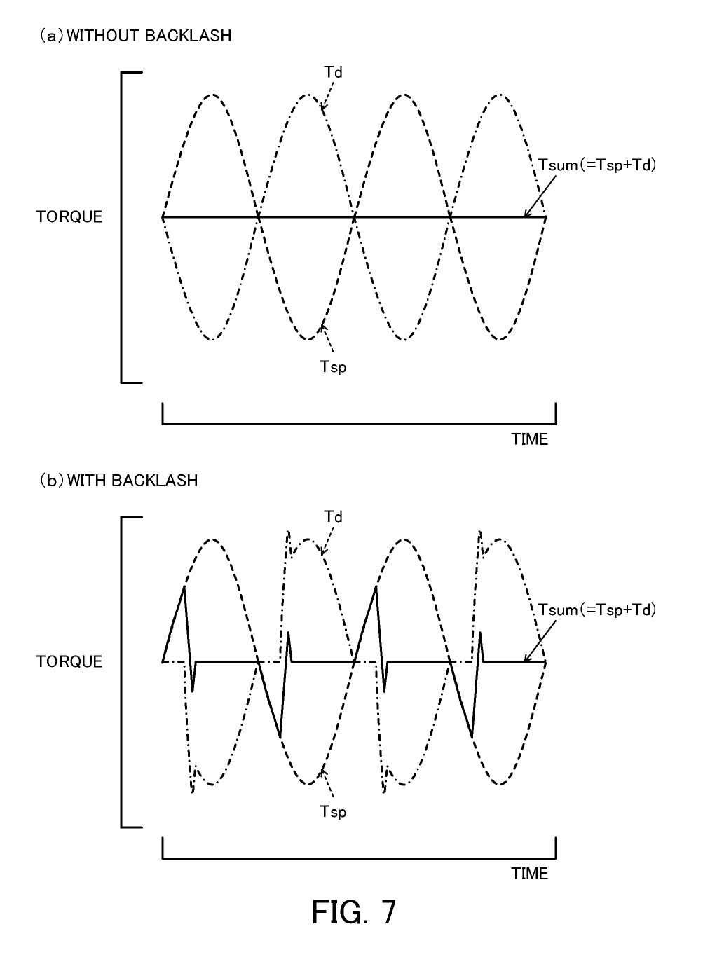

FIG. 7 is a diagram illustrating one example of time changes of a torque Tsp transmitted to the driven member 15 via the first torque transmission path TP1 (via the first springs SP1 and the second springs SP2 as the elastic bodies), an inertia torque Td transmitted to the driven member 15 via the rotating inertia mass damper 20, and a torque Tsum by combining the torque Tsp with the inertia torque Td when the rotation speed of the engine EG is a rotation speed corresponding to either the antiresonance point A1 or the antiresonance point A2. FIG. 7(a) shows time changes without the backlash between the gear teeth of the gears engaging with each other (the sun gear and the pinion gear or the pinion gear and ring gear), and FIG. 7(b) shows time changes with the backlash.

As shown in FIG. 7(a), when there is no backlash between the gear teeth of the gears engaging with each other, the torque Tsp and the inertia torque Td are cancelled out each other, so that the torque Tsum is equal to the value 0. This extremely effectively damps the vibration of the driven member 15. It is, however, difficult to eliminate the backlash between the gear teeth of the gears engaging with each other. Even if the backlash is successfully eliminated, this makes it difficult to rotate the pinion gears 23 and the ring gear 25 smoothly. As shown in FIG. 7(b), when there is a backlash between the gear teeth of the gears engaging with each other, on the other hand, the backlash between the gear teeth of the gears engaging with each other is eliminated during inversion of the inertia torque Td, so that the inertia torque Td becomes equal to the value 0 (i.e., no torque is transmitted to the driven member 15 via the rotating inertia mass damper 20). In other words, the torque Tsum does not become equal to the value 0 while the backlash between the gear teeth of the gears engaging with each other is eliminated. Even in the case where the rotation speed of the engine EG is equal to the rotation speed corresponding to either the antiresonance point A1 or the antiresonance point A2, it is difficult to effectively damp the vibration of the torque transmitted to the driven member 15 while the backlash between the gear teeth of the gears engaging with each other is eliminated. An idling time required for elimination of the backlash between the gear teeth is expected to increase with an increase in degree of backlash between the gear teeth of the gears engaging with each other. The configuration of the embodiment displaces the internal teeth 25t (25ta and 25tb) of the two gear main bodies 250 (250a and 250b) of the ring gear 25 from each other in the circumferential direction of the gear main bodies 250 to reduce the backlash between the internal teeth 25ta and 25tb of the ring gear 25 and the gear teeth 23t of the pinion gear 23. This shortens the idling time and thereby more effectively damps the vibration of the driven member 15. The above description regards the case where the rotation speed of the engine EG is equal to the rotation speed corresponding to the antiresonance point A1 or the antiresonance point A2. The description is similarly applied to the case where the rotation speed of the engine EG is not equal to the rotation speed corresponding to the antiresonance point A1 or the antiresonance point A2.

A vehicle equipped with the engine EG as the generation source of the power for driving may be configured to further reduce a lockup rotation speed Nlup of the lockup clutch and mechanically transmit the torque from the engine EG to the transmission TM at the earlier timing. This configuration enhances the power transmission efficiency between the engine EG and the transmission TM and thereby further improves the fuel consumption of the engine EG. The vibration transmitted from the engine EG to the drive member 11 via the lockup clutch, however, increases in a low rotation speed range of about 500 rpm to 1500 rpm that may be a set range of the lockup rotation speed Nlup. An increase in the vibration level is especially remarkable in a vehicle equipped with an engine EG of a less number of cylinders, for example, a 3-cylinder or 4-cylinder engine EG. In order to prevent a large vibration from being transmitted to the transmission TM or the like during or immediately after establishment of the lockup, there is a need to further reduce the vibration level in a rotation speed range around the lockup rotation speed Nlup of the entire damper device 10 (driven member 15) configured to transmit the torque (vibration) from the engine EG to the transmission TM in the state of establishment of the lockup.

By taking into account the foregoing, the inventors have configured the damper device 10 to form the low rotation-side (low frequency-side) antiresonance point A1 at the rotation speed of the engine EG in a range of 500 rpm to 1500 rpm (expected set range of the lockup rotation speed Nlup), based on the lockup rotation speed Nlup determined for the lockup clutch 8. Two solutions ω1 and ω2 of Expression (5) given above may be obtained as Expressions (6) and (7) given below from the quadratic formula, where ω1<ω2. A frequency fa1 of the low rotation-side (low frequency-side) antiresonance point A1 (hereinafter called “minimum frequency”) is expressed by Expression (8) given below, and a frequency fa2 (fa2>fa1) of the high rotation-side (high frequency-side) antiresonance point A2 is expressed by Expression (9) given below. Additionally, the rotation speed Nea1 of the engine EG corresponding to the minimum frequency fa1 is expressed by Nea1=(120/n)·fa1, where “n” denotes the number of cylinders of the engine EG.

$$\begin{matrix}[ Math . 5 ] & \\ {ω}_{1}^{2} = \frac{( {k}_{1} + {k}_{2} ) - \sqrt{{( {k}_{1} + {k}_{2} )}^{2} - 4 \cdot \frac{{J}_{2}}{{J}_{i}} \cdot {k}_{1} \cdot {k}_{2} \cdot \frac{1}{λ ( 1 + λ )}}}{2 \cdot {J}_{2}} & ( 6 ) \\ {ω}_{2}^{2} = \frac{( {k}_{1} + {k}_{2} ) + \sqrt{{( {k}_{1} + {k}_{2} )}^{2} - 4 \cdot \frac{{J}_{2}}{{J}_{i}} \cdot {k}_{1} \cdot {k}_{2} \cdot \frac{1}{λ ( 1 + λ )}}}{2 \cdot {J}_{2}} & ( 7 ) \\ {fa}_{1} = \frac{1}{2 π} \sqrt{\frac{( {k}_{1} + {k}_{2} ) - \sqrt{{( {k}_{1} + {k}_{2} )}^{2} - 4 \cdot \frac{{J}_{2}}{{J}_{i}} \cdot {k}_{1} \cdot {k}_{2} \cdot \frac{1}{λ ( 1 + λ )}}}{2 \cdot {J}_{2}}} & ( 8 ) \\ {fa}_{2} = \frac{1}{2 π} \sqrt{\frac{( {k}_{1} + {k}_{2} ) + \sqrt{{( {k}_{1} + {k}_{2} )}^{2} - 4 \cdot \frac{{J}_{2}}{{J}_{i}} \cdot {k}_{1} \cdot {k}_{2} \cdot \frac{1}{λ ( 1 + λ )}}}{2 \cdot {J}_{2}}} & ( 9 )\end{matrix}$$

The damper device 10 accordingly selects and sets the combined spring constant k1 of the plurality of first springs SP1, the combined spring constant k2 of the plurality of second springs SP2, the moment of inertia J2 of the intermediate member 12 (taking into account (summing up) the moments of inertia of the turbine runner 5 and the like coupled to integrally rotate) and the moment of inertia Ji of the ring gear 25 as the mass body of the rotating inertia mass damper 20, such as to satisfy Expression (10) given below. Accordingly, the damper device 10 determines the spring constants k1 and k2 of the first and the second springs SP1 and SP2, the moment of inertia J2 of the intermediate member 12, the moment of inertia Ji of the ring gear 25, and the gear ratio λ of the planetary gear 21, based on the minimum frequency fa1 described above (and the lockup rotation speed Nlup). In design of the damper device 10, ignoring the moment of inertia of the pinion gear 23 as shown in Expressions (2) to (9) given above causes no practical problem, but the moment of inertia of the pinion gear 23 may additionally be taken into account in Expression (2) and the like. In the latter case, the spring constants k1 and k2 of the first and the second springs SP1 and SP2, the moment of inertia J2 of the intermediate member 12, the moment of inertia Ji of the ring gear 25, the gear ratio λ of the planetary gear 21, and the moment of inertia of the pinion gear 23 may be determined, based on the minimum frequency fa1 (and the lockup rotation speed Nlup).

$$\begin{matrix}[ Math . 6 ] & \\ 500 rpm \leq \frac{120}{n} {fa}_{1} \leq 1500 rpm & ( 10 )\end{matrix}$$

Setting the low rotation-side antiresonance point A1 where the vibration amplitude Θ3 of the driven member 15 theoretically become equal to zero (is further decreasable) in the low rotation speed range from 500 rpm to 1500 rpm (expected set range of the lockup rotation speed Nlup) as described above allows for the lockup (coupling of the engine EG with the drive member 11) at the lower rotation speed.

In the configuration of the damper device 10 to satisfy Expression (10), it is preferable to select and set the spring constants k1 and k2 and the moments of inertia J2 and Ji, such that the frequency of the low rotation-side (low frequency-side) resonance (resonance point R1) occurring in the first torque transmission path TP1 is lower than the above minimum frequency fa1 and is a lowest possible value. This further lowers the minimum frequency fa1 and allows for the lockup at the further lower rotation speed.

Furthermore, compared with a configuration of setting only a single antiresonance point (shown by the broken line curve in FIG. 6), the configuration of setting two antiresonance points A1 and A2 enables the antiresonance point A1 having the minimum frequency (fa1) out of the two antiresonance points A1 and A2 to be shifted to the lower frequency side. Additionally, as understood from FIG. 6, the configuration of setting two antiresonance points A1 and A2 enables the vibration of the engine EG transmitted from the drive member 11 to the driven member 15 via the first torque transmission path TP1 (shown by the one-dot chain line curve in FIG. 6) to be effectively damped by the vibration transmitted from the drive member 11 to the driven member 15 via the rotating inertia mass damper 20 (shown by the two-dot chain line curve in FIG. 6) in a relatively wide rotation speed range between the two antiresonance points A1 and A2.

This further improves the vibration damping effect of the damper device 10 in the low rotation speed range of the lockup range that is likely to have the larger vibration from the engine EG. In the damper device 10, on the occurrence of the second resonance (resonance point R2 shown in FIG. 6: second resonance described above), the intermediate member 12 starts vibrating in the opposite phase to the phase of the vibration of the driven member 15. As shown by the one-dot chain line curve in FIG. 6, the phase of the vibration transmitted from the drive member 11 to the driven member 15 via the first torque transmission path TP1 becomes identical with the phase of the vibration transmitted from the drive member 11 to the driven member 15 via the rotating inertia mass damper 20.

With a view to further improving the vibration damping performance around the lockup rotation speed Nlup in the damper device 10 configured as described above, there is a need to make the lockup rotation speed Nlup appropriately away from the rotation speed of the engine EG corresponding to the resonance point R2. Accordingly, in the configuration of the damper device 10 to meet Expression (10), it is preferable to select and set the spring constants k1 and k2 and the moments of inertia J2 and Ji such as to satisfy Nlup≤(120/n)·fa1 (=Nea1). This configuration establishes the lockup by the lockup clutch 8, while effectively suppressing transmission of the vibration to the input shaft IS of the transmission TM. This configuration also enables the damper device 10 to remarkably effectively damp the vibration from the engine EG immediately after establishment of the lockup.

The vibration damping performance of the damper device 10 is remarkably effectively improved by designing the damper device 10 based on the frequency (minimum frequency) fa1 of the antiresonance point A1 as described above. According to the inventors' studies and analyses, it is confirmed that the configuration of the damper device 10 to satisfy, for example, 900 rpm≤(120/n)·fa1≤1200 rpm provides the extremely positive practical results when the lockup rotation speed Nlup is set to a value approximate to, for example, 1000 rpm.

With a view to further lowering the actual vibration amplitude of the driven member 15 in the neighbor hood of the antiresonance points A1 and A2 described above, there is a need to minimize the hystereses of both the rotating inertia mass damper 20 and the first torque transmission path TP1 including the intermediate member 12 and the first and the second springs SP1 and SP2. In other words, the damper device 10 requires to minimize both a phase shift of the vibration transmitted to the driven member 15 via the first torque transmission path TP1 due to the hysteresis of the first and the second springs SP1 and SP2 and a phase shift of the vibration transmitted to the driven member 15 via the rotating inertia mass damper 20 due to the hysteresis of the rotating inertia mass damper 20.

In the damper device 10, the external teeth 15t are formed on the driven member 15 serving as the sun gear of the planetary gear 21 of the rotating inertia mass damper 20 to be located on the outer side in the radial direction of the first and the second springs SP1 and SP2 that are provided to transmit the torque between the drive member 11 and the driven member 15. In other words, the first and the second springs SP1 and SP2 are located on the inner side in the radial direction of the planetary gear 21 of the rotating inertia mass damper 20. This configuration reduces the centrifugal force applied to the first and the second springs SP1 and SP2 and reduces the frictional force (sliding resistance) generated when the first and the second springs SP1 and SP2 are pressed against the spring support structures 121s and 122s by the centrifugal force. Accordingly, the damper device 10 can effectively reduce the hysteresis of the first and the second springs SP1 and SP2.

An energy loss Jh due to the hysteresis of the rotating inertia mass damper 20 is expressed as Jh=ΔT·θ, where “Jh” denotes the energy loss due to the hysteresis of the rotating inertia mass damper 20; “ΔT” denotes a difference (hereinafter called “torque difference”) between the torque transmitted to the driven member 15 (sun gear) via the rotating inertia mass damper 20 with an increase in relative displacement of the drive member 11 to the driven member 15 and the torque transmitted to the driven member 15 via the rotating inertia mass damper 20 with a decrease in relative displacement of the drive member 11 to the driven member 15; and “θ” denotes the flight angle of the drive member 11 relative to the driven member 15. The energy loss Jh is also expressed as Jh=μ·Fr·x, where “μ” denotes a dynamic friction coefficient between the ring gear 25 and the pinion gear 23; “Fr” denotes a vertical load (force in the axial direction) applied to the ring gear 25 due to, for example, the pressure in the fluid chamber 9; and “x” denotes a sliding distance of the ring gear 25 relative to the pinion gear 23.

A relationship of ΔT·dθ/dt=μ·Fr·dx/dt is obtained by time derivation of both sides of a relational expression of ΔT≤θ=μ·Fr·x. The torque difference ΔT, i.e., the hysteresis of the rotating inertia mass damper 20 is thereby expressed as ΔT=μ·Fr·(dx/dt)/(dθ/dt). The time derivative value dx/dt of the sliding distance x in the right side of the relational expression showing the torque difference ΔT indicates a relative velocity Vrp of the ring gear 25 to the pinion gear 23. The hysteresis of the rotating inertia mass damper 20 accordingly decreases with a decrease in the relative velocity Vrp of the ring gear 25 to the pinion gear 23 that is the support member of the ring gear 25, i.e., with a decrease in the relative velocity of the mass body to the support member serving to restrict the movement in the axial direction of the mass body.

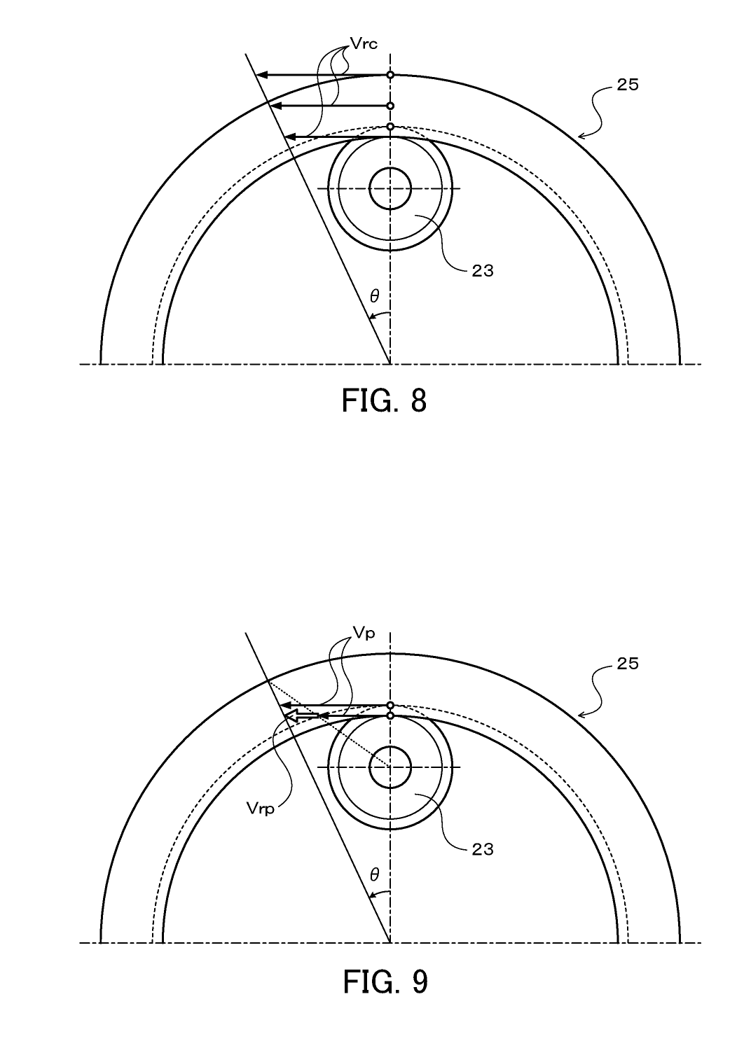

In the case where the respective sides of the ring gear 25 as the mass body are supported by the first and the second input plate members 111 and 112 that constitute the drive member 11 as the carrier of the planetary gear 21, the hysteresis of the rotating inertia mass damper 20 is dependent on a relative velocity Vrc of the ring gear 25 to the drive member 11. The relative velocity Vrc of the ring gear 25 to the drive member 11 in the state that the drive member 11 is twisted relative to the driven member 15 by an angle θ is shown in FIG. 8. The relative velocity Vrc is relatively high in the vicinity of the inner circumference of the ring gear 25 and further increases from the inner circumference toward the outer circumference of the ring gear 25. Accordingly, the configuration that the respective sides of the ring gear 25 as the mass body are supported by the first and the second input plate members 111 and 112 fails to effectively reduce the hysteresis of the rotating inertia mass damper 20.

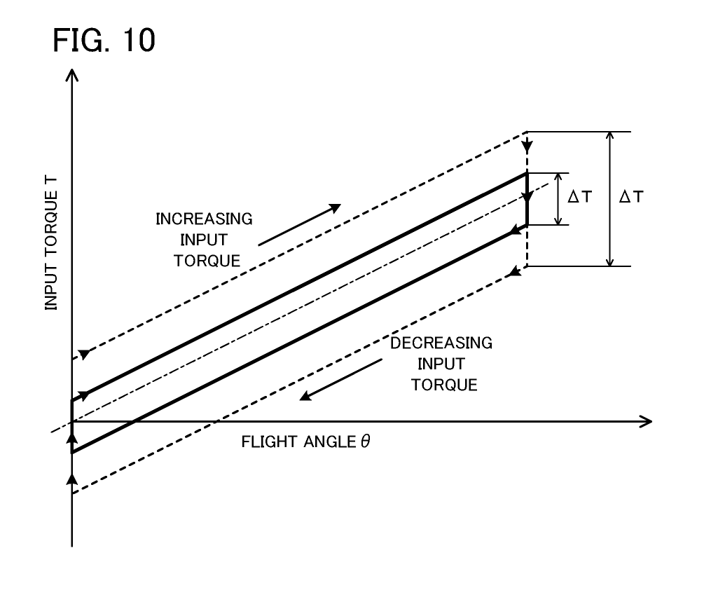

The pinion gear 23 revolves at a circumferential velocity Vp that is equal to the circumferential velocities of the first and the second input plate members 111 and 112 as the carrier and rotates about the pinion shaft 24. The relative velocity Vrp of the ring gear 25 to the pinion gear 23 becomes approximately equal to zero in the vicinity of an engagement position of the internal teeth 25t of the ring gear 25 and the gear teeth 23t of the pinion gear 23 (a point on the broken line in FIG. 9, similarly to FIG. 8). The relative velocity Vrp of the ring gear 25 to the pinion gear 23 thus becomes significantly lower than the relative velocity Vrc of the ring gear 25 to the drive member 11 (carrier) as shown by an open arrow in FIG. 9 and becomes lower than a relative velocity (not shown) of the ring gear 25 to the driven member 15 (sun gear). Accordingly, as shown by the solid line in FIG. 10, the damper device 10 configured to restrict the movement in the axial direction of the ring gear 25 as the mass body by the pinion gear 23 of the planetary gear 21 effectively reduces the hysteresis of the rotating inertial mass damper 20, i.e., the torque difference ΔT, compared with the configuration that the respective sides of the ring gear 25 are supported by the first and the second input plate members 111 and 112 (shown by the broken line in FIG. 10).

According to the embodiment, the ring gear 25 includes the two side plates (supported portions) 251 (251a, 251b) fixed to the side surfaces on the respective sides of the two gear main bodies 250 (250a, 250b) such that the inner circumferential surfaces of the side plates 251 are located on the slightly inner side in the radial direction of the tips of the internal teeth 25t (25ta, 25tb). The movement in the axial direction of the ring gear 25 is restricted at least the side surfaces of the gear teeth 23t of the pinion gear 23. The pinion gear 23 restricts the movement in the axial direction of the ring gear 25 in the vicinity of the engagement position of the ring gear 25 and the pinion gear 23 (of the internal teeth 25ta and 25tb and the gear teeth 23t) where the relative velocity Vrp of the ring gear 25 to the pinion gear 23 becomes approximately equal to zero. This configuration thus extremely effectively reduces the hysteresis (loss) of the rotating inertia mass damper 20.

As described above, the damper device 10 effectively reduces both the hysteresis in the first torque transmission path TP1 and the hysteresis of the rotating inertia mass damper 20 and effectively lowers the actual vibration amplitude of the driven member 15 in the vicinity of the antiresonance points A1 and A2. Accordingly, the vibration damping performance of the damper device 10 including the rotating inertia mass damper 20 can be further improved by making the frequency fa1 of the low rotation-side antiresonance point A1 equal to (closer to) the frequency of a vibration (resonance) to be damped in the above range or by making the frequency fa2 of the high rotation-side antiresonance point A2 equal to the frequency of another vibration (resonance) to be damped. Reducing the hysteresis of the rotating inertia mass damper 20 as described above is significantly effective to further improve the vibration damping effect of the rotating inertia mass damper 20.

In the damper device 10, the driven member 15 serving as the sun gear, the plurality of pinion gears 23 and the ring gear 25 at least partly overlap in the axial direction with the first and the second springs SP1 and SP2 (and the inner springs SPi) when being viewed in the radial direction of the damper device 10. This configuration suppresses an increase in axial length of the damper device 10 and locates the ring gear 25 on the outer circumferential side of the damper device 10 to further increase the moment of inertia of the ring gear 25 and more efficiently obtain the inertia torque, while suppressing an increase in weight of the ring gear 25 serving as the mass body of the rotating inertia mass damper 20.

Furthermore, in the damper device 10, the rotation speed of the ring gear 25 as the mass body can be increased to be higher than the rotation speed of the drive member 11 (carrier) by the function of the planetary gear 21. This configuration reduces the weight of the ring gear 25 as the mass body, while effectively assuring the inertia torque that is applied from the rotating inertia mass damper 20 to the driven member 15, and enhances the flexibility in design of the rotating inertial mass damper 20 and the entire damper device 10. The rotating inertia mass damper 20 (planetary gear 21) may, however, be configured to decrease the rotation speed of the ring gear 25 to be lower than the rotation speed of the drive member 11, according to the magnitude of the moment of inertia of the ring gear 25 (mass body). The planetary gear 21 may be a double pinion-type planetary gear. Moreover, any of the external teeth 15t of the driven member 15, the gear teeth 23t of the pinion gear, and the internal teeth 25t of the ring gear 25 may be helical teeth of spiral tooth trace or may have a tooth trace extended parallel to the axial center.

The configuration of setting the two antiresonance points A1 and A2 enables the antiresonance point A1 to be shifted to the lower frequency side as described above. According to the specifications of a vehicle, a prime mover or the like which the damper device 10 is applied to, a multiple root of Expression (5) (=1/2π·√{(k1+k2)/(2·J2)} may be specified as the above minimum frequency fa1. Determining the spring constants k1 and k2 of the first and the second springs SP1 and SP2 and the moment of inertia J2 of the intermediate member 12 based on the multiple root of Expression (5) also improves the vibration damping effect of the damper device 10 in the low rotation speed range of the lockup range that is likely to have the larger vibration from the engine EG as shown by the broken line curve in FIG. 6.

In the damper device 10 described above, springs having identical specifications (spring constants) are employed as the first and the second springs SP1 and SP2. This is, however, not essential. More specifically, the spring constants k1 and k2 of the first and the second springs SP1 and SP2 may be different from each other (k1>k2 or k1<k2). This further increases the value in the root term (discriminant) in Expression (6) and in Expression (8) to increase the interval between the two antiresonance points A1 and A2 and thereby further improve the vibration damping effect of the damper device in the low frequency range (low rotation speed range). In this case, the damper device 10 may be provided with a stopper to restrict the deflection of one of the first and the second springs SP1 and SP2 (for example, one spring having the lower stiffness).

Furthermore, the ring gear 25 of the rotating inertia mass damper 20 described above includes the two side plates 251a and 251b fixed to the two gear main bodies 250a and 250b such that the inner circumferential surfaces of the side plates 251a and 251b are located on the slightly inner side in the radial direction of the tips of the internal teeth 25t. This configuration is, however, not essential. The requirement is that the respective side plates 251a and 251b (supported portions) of the ring gear 25 are fixed to the two gear main bodies 250a and 250b such that the inner circumferential surfaces of the side plates 251a and 251b are located on the inner side in the radial direction of the bottoms of the internal teeth 25ta and 25tb and are located on the outer side in the radial direction of the pinion shaft 24 provided to support the pinion gear 23. The radial direction support structures 230s of the pinion gear 23 (gear main body 230) may have smaller diameters than those described above. The configuration that the inner circumferential surfaces of the respective side plates 251a and 251b of the ring gear 25 are arranged closer to the pinion shaft 24 enables the movement in the axial direction of the ring gear 25 to be extremely effectively restricted by the pinion gear 23.

With a view to restricting the movement in the axial direction of the ring gear 25 by the pinion gear 23, the two side plates 251a and 251b may be omitted from the ring gear 25, and the pinion gear 23 may be provided with a pair of support structures that are arranged on the respective sides of the gear teeth 23t to be protruded outward in the radial direction and that are formed, for example, in a ring shape. In this modification, it is preferable that the support structures of the pinion gear 23 are formed to be opposed to at least side surfaces of the internal teeth 25t of the ring gear 25. The support structures of the pinion gear 23 may be formed to be opposed to parts of the side surfaces of the two gear main bodies 250a and 250b.

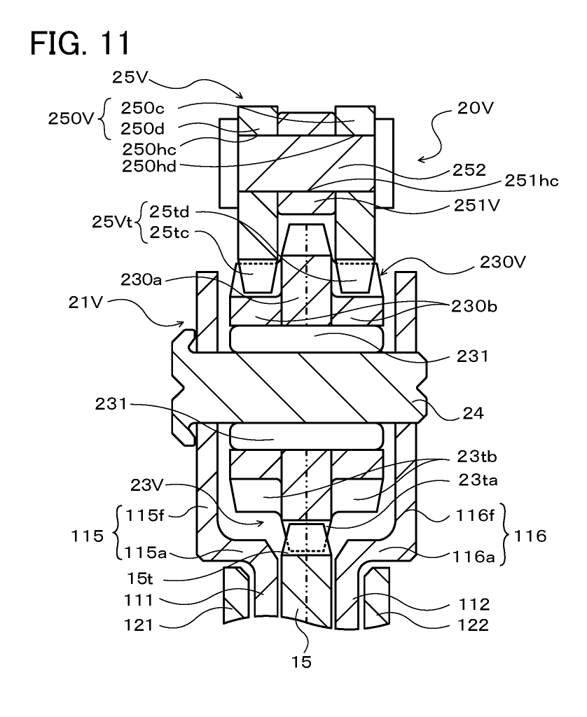

The ring gear 25 of the rotating inertia mass damper 20 includes the two gear main bodies 250a and 250b and the two side plates 251a and 251b arranged across the two gear main bodies 250 in the axial direction. This configuration is, however, not essential. For example, in a rotating inertia mass damper 20V shown in FIG. 11, a planetary gear 21V may include a driven member 15 serving as the sun gear, a plurality of pinion gears 23V, first and second input plate members 111 and 112 serving as the carrier, and a ring gear 25V. The following mainly describes differences of the rotating inertia mass damper 20V shown in FIG. 11 from the rotating inertia mass damper 20 shown in FIG. 4.

The pinion gear 23V includes a ring-shaped gear main body 230V; and a plurality of needle bearings 231 placed between an inner circumferential surface of the gear main body 230V and an outer circumferential surface of a pinion shaft 24. The gear main body 230V of the pinion gear 23V includes a large diameter portion 230a that has gear teeth 23ta engaging with external teeth (gear teeth) 15t of the driven member 15; and small diameter portions 230b that are protruded on respective sides in the axial direction of the large diameter portion 230a, that have smaller diameters than the diameter of the large diameter portion 230a and that have gear teeth 23tb engaging with internal teeth (gear teeth) 25Vt (25tc and 25td) of the ring gear 25V.

The ring gear 25V has two gear main bodies 250V (250c and 250d) as two ring-shaped gear members that respectively have internal teeth 25Vt (25tc and 25td) on inner circumferences thereof; an inertia member 251V formed in an annular shape; and a plurality of rivets 252 as a plurality of coupling members to fix the inertia member 251V placed between the two gear main bodies 250c and 250d. The two gear main bodies 250c and 250d, the inertia member 251V and the plurality of rivets 252 are integrated with one another to serve as a mass body of the rotating inertia mass damper 20V.

The two gear main bodies 250c and 250d have elliptical connection holes 250hc and 250hd with their longitudinal sides in the circumferential direction. The inertia member 251V includes a connection hole 251hc. The two gear main bodies 250c and 250d and the inertia member 251V are coupled with each other such that the inertia member 251V is placed between the two gear main bodies 250c and 250d and the internal teeth 25tc and 25td of the two gear main bodies 250c and 250d are shifted from each other in the circumferential direction of the gear main bodies 250c and 250d via the rivets 252 inserted through the connection holes 250hc, 251hc and 250hd. Like the rotating inertia mass damper 20 of FIG. 4, the configuration of the rotating inertia mass damper 20V of FIG. 11 reduces the backlash between the internal teeth 25tc and 25td of the two gear main bodies 250V (250c and 250d of the ring gear 25V and the gear teeth 23ta and 23tb of the gear main body 230V of the pinion gear 23V.

When the gear teeth 23tb of the small diameter portion 230b of the gear main body 230V of each of the pinion gears 23V is engaged with the internal teeth 25tc and 25td of the two gear main bodies 250c and 250d of the ring gear 25V, the inner surfaces of the internal teeth 25tc and 25td are opposed to side surfaces of the gear teeth 23ta of the large diameter portion 230a of the gear main body 230V of the pinion gear 23V and side surfaces of inner circumferential portions than the bottoms of the gear teeth 23ta. This configuration restricts the movement in the axial direction of the ring gear 25V by at least the side surfaces of the gear teeth 23ta of the large diameter portion 230a of the pinion gear 23V. This accordingly causes the movement in the axial direction of the ring gear 25V to be restricted by the pinion gear 23V in the vicinity of an engagement position of the ring gear 25V and the pinion gear 23V (the internal teeth 25tc and 25td and the gear teeth 23ta and 23tb) where a relative velocity of the ring gear 25V to the pinion gear 23V becomes approximately equal to zero. This extremely effectively reduces the hysteresis (loss) of the rotating inertia mass damper 20.

The planetary gear 21 of the rotating inertia mass damper 20 described above includes one driven member 15 having the external teeth 15t and serving as the sun gear; the pinion gears 23, each including one gear main body 230 provided with the gear teeth 23t; and the ring gear 25 including the two gear main bodies 250 (250a and 250b) provided with the internal teeth 25t (25ta and 25tb), and the internal teeth 25t of the two gear main bodies 250 are shifted to each other in the circumferential direction. This configuration is, however, not essential. According to one modification, the ring gear 25 may include only one gear main body 250, the planetary gear 21 may include two driven members 15 (divided into two as shown by the two-dot chain line in FIG. 4), and external teeth 15t of the two driven members 15 may be shifted to each other in the circumferential direction. This configuration reduces the backlash between the external teeth 15t of the two driven members 15 and the gear teeth 23t of the gear main body 230 of the pinion gear 23. According to another modification, the ring gear 25 may include only one gear main body 250, the pinion gear 23 may include two gear main bodies 230 (divided into two as shown by the two-dot chain line in FIG. 4), and gear teeth 23t of the two gear main bodies 230 may be shifted to each other in the circumferential direction. This configuration reduces the backlash between the gear teeth 23t of the two gear main bodies 230 of the pinion gear 23 and the external teeth 15t of the driven member 15 along with the internal teeth 25t of the gear main body 250 of the ring gear 25. According to another modification, any multiple (two or all three) members of the driven member 15, the gear main body 230 of the pinion gear 23 and the gear main body 250 of the ring gear 25 may be respectively divided into two, and gear teeth of the member divided into two may be shifted to each other in the circumferential direction. The member divided into two among the driven member 15, the gear main body 230 and the gear main body 250 may have gear teeth shifted to each other in the circumferential direction and coupled with each other by means of a rivet or may be configured as a scissors gear having gear teeth shifted to each other in the circumferential direction by the elastic force of an elastic body. The above description regards the planetary gear 21 of the rotating inertia mass damper 20 but is similarly applicable to the planetary gear 21V of the rotating inertia mass damper 20V. For example, the planetary gear 21V may include two driven members 15 (divided into two as shown by the two-dot chain line in FIG. 11), and external teeth 15t of the two driven members 15 may be shifted to each other in the circumferential direction. In another example, the pinion gear 23V may include two gear main bodies 230V (divided into two as shown by the two-dot chain line in FIG. 11), gear teeth 23ta of the two gear main bodies 230V may be shifted to each other in the circumferential direction, and gear teeth 23tb of the two gear main bodies 230V may be shifted to each other in the circumferential direction. In yet another example, all the driven member 15, the gear main body 230V of the pinion gear 23V and the gear main body 250V of the ring gear 25V may be divided into two, and gear teeth of each member divided into two may be shifted to each other in the circumferential direction.

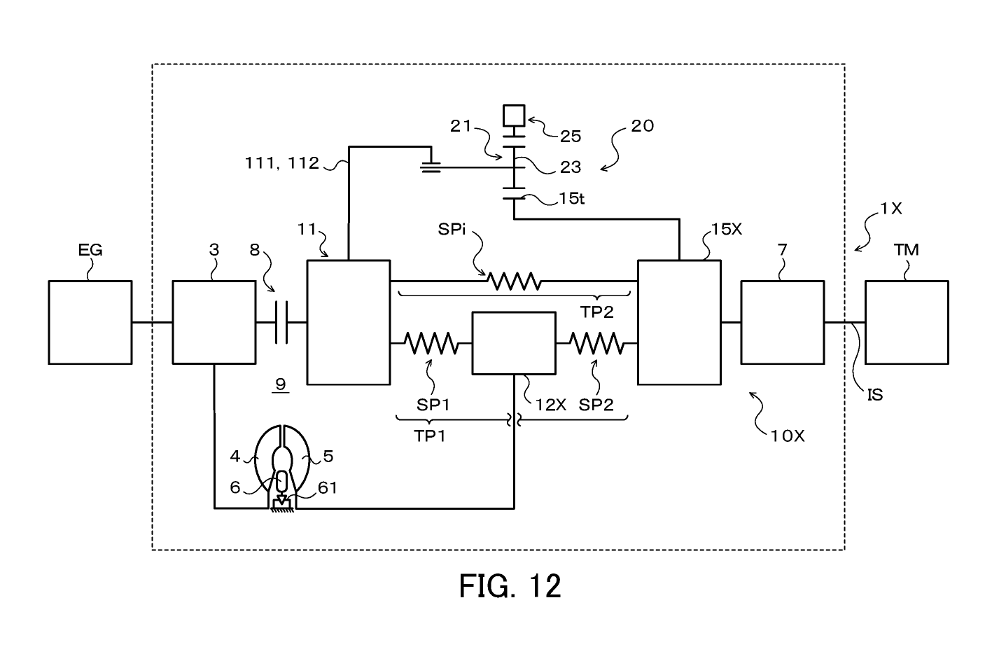

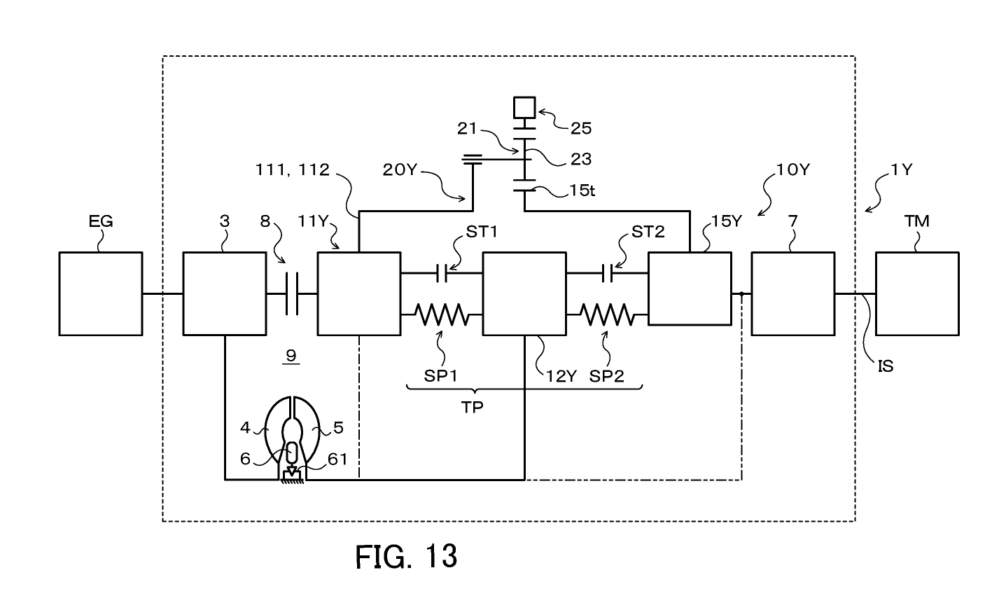

As shown in a damper device 10X of a starting device 1X of FIG. 12, an intermediate member 12X may be coupled with a turbine runner 5 to integrally rotate with the turbine runner 5, instead of a driven member 15X coupled with the turbine runner 5 to integrally rotate with the turbine runner 5. This configuration further increases a substantial moment of inertia J2 of the intermediate member 12X (sum of moments of inertia of the intermediate member 12X, the turbine runner 5 and the like). This modification further lowers the frequency fa1 of the antiresonance point A1 and enables the antiresonance point A1 to be set on the lower rotation side (lower frequency side) as understood from Expression (8).

According to a modification, in the damper device 10 or 10X, the sun gear of the planetary gear 21 may be coupled with (integrated with) the drive member 11, and the driven member 15X may be configured as the carrier of the planetary gear 21. According to another modification, in the damper device 10 or 10X, the sun gear of the planetary gear 21 may be coupled with (integrated with) the intermediate member 12 or 12X, and the drive member 11 or the driven member 15X may be configured as the carrier of the planetary gear 21. According to yet another modification, in the damper device 10 or 10X, the intermediate member 12 or 12X may be configured as the carrier of the planetary gear 21, and the sun gear of the planetary gear 21 may be coupled with (integrated with) the drive member 11 or the driven member 15X. The combination of two members out of the sun gear, the carrier and the ring gear of the planetary gear 21 respectively coupled with (integrated with) any two of the drive member 11, the driven member 15X and the intermediate member 12 or 12X and one member serving as the mass body is not limited to the combinations described above.

FIG. 13 is a schematic configuration diagram illustrating a starting device 1Y including a damper device 10Y according to another modification of the present disclosure. Like components to those of the starting device 1 and the damper device 10 or the like described above among components of the starting device 1Y and the damper device 10Y are expressed by like reference signs, and the duplicated description is omitted.

The damper device 10Y shown in FIG. 13 includes a drive member (input element) 11Y, an intermediate member (intermediate element) 12Y and a driven member (output element) 15Y, as rotational elements. The damper device 10Y also includes a plurality of first springs (first elastic body) SP1 configured to transmit the torque between the drive member 11Y and the intermediate member 12Y; and a plurality of second springs (second elastic body) SP2 configured to work respectively in series with the corresponding first springs SP1 and transmit the torque between the intermediate member 12Y and the driven member 15Y, as torque transmission elements (torque transmission elastic body). The plurality of first springs (first elastic body) SP1, the intermediate member 12Y and the plurality of second springs (second elastic body) SP2 constitute a torque transmission path TP between the drive member 11Y and the driven member 15Y. Furthermore, the intermediate member 12Y is coupled with the turbine runner 5 to integrally rotate with the turbine runner 5 as illustrated. The turbine runner 5 may be coupled with either one of the drive member 11Y and the driven member 15Y as shown by the two-dot chain line in FIG. 13.

Like the rotating inertia mass damper 20 described above, a rotating inertia mass damper 20Y is configured by a single pinion-type planetary gear 21. The rotating inertia mass damper 20Y is provided in parallel to the torque transmission path TP between the drive member 11Y and the driven member 15Y. In the rotating inertia mass damper 20Y, the drive member 11Y (first and second input plate members 111 and 112) rotatably supports a plurality of pinion gears 23 and serves as the carrier of the planetary gear 21. The driven member 15Y has external teeth 15t and serves as the sun gear of the planetary gear 21.

In the rotating inertia mass damper 20Y, the pinion gear 23 serves to restrict the movement in the axial direction of the ring gear 25 as the mass body.

The damper device 10Y also includes a first stopper ST1 configured to restrict relative rotation of the drive member 11Y to the intermediate member 12Y, i.e., to restrict deflection of the first springs SP1; and a second stopper ST2 configured to restrict relative rotation of the intermediate member 12Y to the driven member 15Y, i.e., to restrict deflection of the second springs SP2. One of the first and the second stoppers ST1 and ST2 restricts the relative rotation of the drive member 11Y to the intermediate member 12Y or the relative rotation of the intermediate member 12Y to the driven member 15Y when the input torque into the drive member 11Y reaches a predetermined torque T1 that is smaller than a torque T2 corresponding to a maximum flight angle θmax of the damper device 10Y and a flight angle of the drive member 11Y relative to the driven member 15Y becomes equal to or larger than a predetermined angle θref. The other of the first and the second stoppers ST1 and ST2 restricts the relative rotation of the intermediate member 12Y to the driven member 15Y or the relative rotation of the drive member 11Y to the intermediate member 12Y when the input torque into the drive member 11Y reaches the torque T2.

This configuration allows for deflections of the first and the second springs SP1 and SP2 until one of the first and the second stoppers ST1 and ST2 operates. When one of the first and the second stoppers ST1 and ST2 operates, deflection of one of the first and the second springs SP1 and SP2 is restricted. When both the first and the second stoppers ST1 and ST2 operate, deflections of both the first and the second springs SP1 and SP2 are restricted. Accordingly, the damper device 10Y has two-step (two-stage) damping characteristics. The first stopper ST1 or the second stopper ST2 may be configured to restrict the relative rotation of the drive member 11Y to the driven member 15Y.

The damper device 10Y having the above configuration has similar functions and advantageous effects to those of the damper device 10 described above. In the damper device 10Y, one of the first and the second springs SP1 and SP2 may be arranged at intervals in the circumferential direction on an outer side of the other in the radial direction. For example, the plurality of first springs SP1 may be arranged at intervals in the circumferential direction in an outer circumferential-side region in the fluid chamber 9, and the plurality of second springs SP2 may be arranged at intervals in the circumferential direction on an inner side in the radial direction of the plurality of first springs SP1. In this configuration, the first springs SP1 and the second springs SP2 may be arranged to partly overlap with each other when being viewed in the radial direction.

According to one modification, in the damper device 10Y, the sun gear of the planetary gear 21 may be coupled with (integrated with) the drive member 11Y, and the driven member 15Y may be configured as the carrier of the planetary gear 21. According to another modification, in the damper device 10Y, the sun gear of the planetary gear 21 may be coupled with (integrated with) the intermediate member 12Y, and the drive member 11Y or the driven member 15Y may be configured as the carrier of the planetary gear 21. According to yet another modification, in the damper device 10Y, the intermediate member 12Y may be configured as the carrier of the planetary gear 21, and the sun gear of the planetary gear 21 may be coupled with (integrated with) the drive member 11Y or the driven member 15Y. The combination of two members out of the sun gear, the carrier and the ring gear of the planetary gear 21 respectively coupled with (integrated with) any two of the drive member 11Y, the driven member 15Y and the intermediate member 12Y and one member serving as the mass body is not limited to the combinations described above.

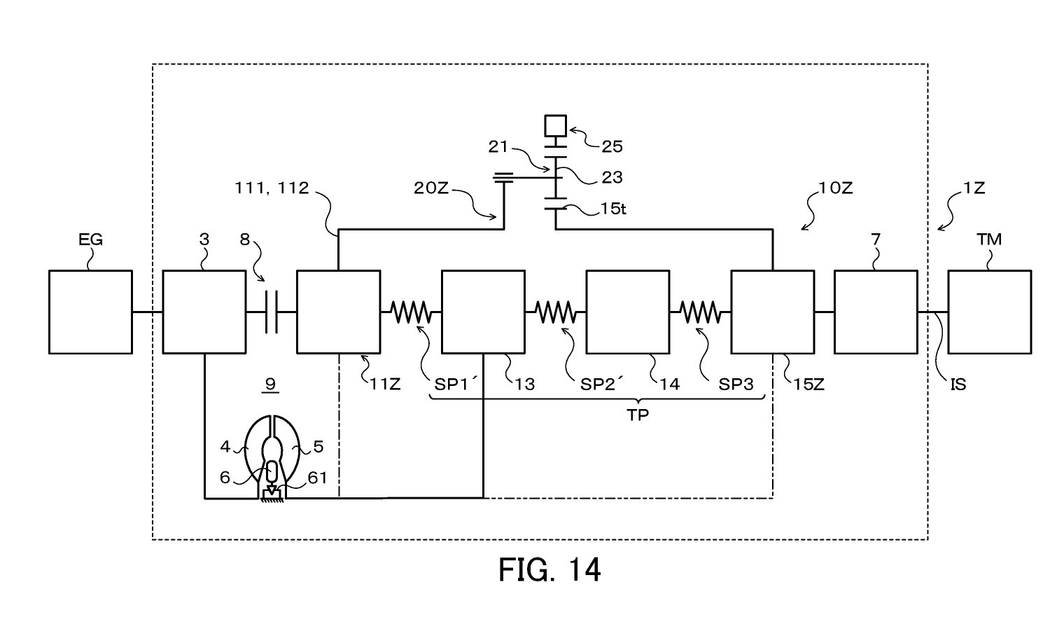

FIG. 14 is a schematic configuration diagram illustrating a starting device including a damper device 10Z according to another modification of the present disclosure. Like components to those of the starting device 1 and the damper device 10 or the like described above among components of the starting device 1Z and the damper device 10Z are expressed by like reference signs, and the duplicated description is omitted.

The damper device 10Z shown in FIG. 14 includes a drive member (input element) 11Z, a first intermediate member (first intermediate element) 13, a second intermediate member (second intermediate element) 14, and a driven member (output element) 15Z, as rotational elements. The damper device 10Z also includes a plurality of first springs (first elastic body) SP1′ configured to transmit the torque between the drive member 11Z and the first intermediate member 13; a plurality of second springs (second elastic body) SP2′ configured to transmit the torque between the first intermediate member 13 and the second intermediate member 14; and a plurality of third springs (third elastic body) SP3 configured to transmit the torque between the second intermediate member 14 and the driven member 15Z, as torque transmission elements (torque transmission elastic body). The plurality of first springs (first elastic body) SP1′, the first intermediate member 13, the plurality of second springs (second elastic body) SP2′, the second intermediate member 14, and the plurality of third springs (third elastic body) SP3 constitute a torque transmission path TP between the drive member 11Z and the driven member 15Z. Like the rotating inertia mass dampers 20 and 20Y described above, a rotating inertia mass damper 20Z is configured by a single pinion gear-type planetary gear 21. The rotating inertia mass damper 20Z is provided in parallel to the torque transmission path TP between the drive member 11Z and the driven member 15Z. Furthermore, the first intermediate member 13 is coupled with the turbine runner 5 to integrally rotate with the turbine runner 5. The turbine runner 5 may be coupled with either one of the drive member 11Z and the driven member 15Z as shown by the two-dot chain line in FIG. 14.

In the damper device 10Z including the first and the second intermediate members 13 and 14, when the deflections of all the first to the third springs SP1′, SP2′ and SP3 are allowed, three resonances occur in the torque transmission path TP. More specifically, resonance of the entire damper device 10Z occurs in the torque transmission path TP due to vibrations of the drive member 11Z and the driven member 15Z in opposite phases when the deflections of the first to the third springs SP1′, SP2′ and SP3 are allowed. Resonance also occurs in the torque transmission path TP due to vibrations of the first and the second intermediate members 13 and 14 in opposite phases to the phases of the vibrations of both the drive member 11Z and the driven member 15Z when the deflections of the first to the third springs SP1′, SP2′ and SP3 are allowed. Resonance further occurs in the torque transmission path TP due to vibration of the first intermediate member 13 in an opposite phase to the phase of the vibration of the drive member 11Z, vibration of the second intermediate member 14 in an opposite phase to the phase of the vibration of the first intermediate member 13 and vibration of the driven member 15Z in an opposite phase to the phase of the vibration of the second intermediate member 14 when the deflections of the first to the third springs SP1′, SP2′ and SP3 are allowed. Accordingly, the damper device 10Z is capable of setting three antiresonance points where the vibration transmitted from the drive member 11Z to the driven member 15Z via the torque transmission path TP and the vibration transmitted from the drive member 11Z to the driven member 15Z via the rotating inertia mass damper 20Z are theoretically cancelled out each other.

Setting a lowest rotation-side first antiresonance point among the three antiresonance points that makes the vibration amplitude of the driven member 15Z theoretically equal to zero (that further decreases the vibration amplitude of the driven member 15Z), in a low rotation speed range from 500 rpm to 1500 rpm (expected set range of the lockup rotation speed Nlup) enables any resonance having the lowest frequency among the resonances occurring in the torque transmission path TP to be shifted to the lower rotation side (lower frequency side) such as to be included in a non-lockup range of the lockup clutch 8. As a result, this allows for establishment of the lockup at the lower rotation speed and extremely effectively improves the vibration damping performance of the damper device 10Z in a low rotation speed range that is likely to have the larger vibration from the engine EG. The damper device 10Z may also make a second antiresonance point on the higher rotation side (higher frequency side) than the first antiresonance point equal to (closer to), for example, (the frequency of) a resonance point of the input shaft IS of the transmission TM or make a third antiresonance point on the higher rotation side (higher frequency side) than the second antiresonance point equal to (closer to), for example, (the frequency of) a resonance point in the damper device 10Z. This effectively suppresses the occurrence of such resonances.

The damper device 10Z may be configured such that three or more intermediate members are included in the torque transmission path TP. The turbine runner 5 may be coupled with the second intermediate member 14 or may be coupled with either one of the drive member 11Z and the driven member 15Z as shown by the two-dot chain line in FIG. 14. According to a modification, in the damper device 10Z, the sun gear of the planetary gear 21 may be coupled with (integrated with) the drive member 11Z, and the driven member 15Z may be configured as the carrier of the planetary gear 21. According to another modification, in the damper device 10Z, the sun gear of the planetary gear 21 may be coupled with (integrated with), for example, the first intermediate member 13, and for example, the first intermediate member 13 may be configured as the carrier of the planetary gear 21. The combination of two members out of the sun gear, the carrier and the ring gear of the planetary gear 21 respectively coupled with (integrated with) any two of the drive member 11Z, the driven member 15Z, the first intermediate member 13 and the second intermediate member 14 and one member serving as the mass body is not limited to the combinations described above.

As described above, a damper device according to the present disclosure comprises a plurality of rotational elements including an input element (11, 11Y, 11Z) which a torque from an engine (EG) is transmitted to and an output element (15, 15X, 15Y, 15Z); an elastic body (SP1, SP1′, SP2, SP2′, SP3) configured to transmit a torque between the input element (11, 11Y, 11Z) and the output element (15, 15X, 15Y, 15Z); and a rotating inertia mass damper (20, 20V, 20Y, 20Z) comprising a mass body (25, 25V); and a planetary gear (21, 21V) configured to rotate the mass body (25, 25V) with relative rotation of a first rotational element that is one of the plurality of rotational elements to a second rotational element that is different from the first rotational element. The planetary gear (21, 21V) includes a sun gear (15, 15t, 15X, 15Y, 15Z); a plurality of pinion gears (23, 23V) configured to engage with the sun gear (15, 15t, 15X, 15Y, 15Z); a carrier (11, 111, 112) configured to support the plurality of pinion gears (23, 23V) in a rotatable manner; and a ring gear (25, 25V) configured to engage with the plurality of pinion gears (23, 23V). At least one of the sun gear (15, 15t, 15X, 15Y, 15Z), the pinion gear (23, 23V) and the ring gear (25, 25V) has two gear members (250, 250a, 250b, 250V, 250c, 250d, 15, 230) that are arranged along an axial direction of the planetary gear (21, 21V) and that are coupled with each other. Gear teeth (25t, 25ta, 25tb, 25Vt, 25tc, 25td, 15t, 23t) of the two gear members (250, 250a, 250b, 250V, 250c, 250d, 15, 230) are shifted to each other in a circumferential direction of the two gear members (250, 250a, 250b, 250V, 250c, 250d, 15, 230), such as to reduce a backlash between the gear teeth (25t, 25ta, 25tb, 25Vt, 25tc, 25td, 15t, 23t) of the two gear members (250, 250a, 250b, 250V, 250c, 250d, 15, 230) and gear teeth of a gear engaging with the two gear members (250, 250a, 250b, 250V, 250c, 250d, 15, 230).

In the damper device of the present disclosure, the torque transmitted to the output element via the elastic body is dependent on (proportional to) a displacement of the elastic body configured to transmit the torque to the output element. The rotating inertia mass damper works in parallel to the elastic body that is placed between the first rotational element and the second rotational element. The torque transmitted to the output element via the rotating inertia mass damper is dependent on (proportional to) a difference between angular accelerations of the first rotational element and the second rotational element, i.e., a twice differentiated value of the displacement of the elastic body placed between the first rotational element and the second rotational element. On the assumption that an input torque transmitted to the input element of the damper device periodically vibrates, the phase of the vibration transmitted to the output element via the elastic body and the phase of the vibration transmitted from the input element to the output element via the rotating inertia mass damper are shifted to each other by 180 degrees. This configuration thus enables an antiresonance point where the vibration amplitude of the output element theoretically becomes equal to zero to be set in the damper device of the present disclosure.

In the damper device of the present disclosure, at least one of the sun gear, the pinion gear and the ring gear of the planetary gear in the rotating inertia mass damper has the two gear members that are arranged along the axial direction of the planetary gear and that are coupled with each other. The gear teeth of the two gear members are shifted to each other in the circumferential direction of the two gear members, such as to reduce the backlash between the gear teeth of the two gear members and the gear teeth of the gear engaging with the two gear members. This configuration accordingly reduces the backlash between the gear teeth of the two gear members and the gear teeth of the gear engaging with the two gear members in the planetary gear and further improves the vibration damping performance of the damper device.

In the damper device according to the above aspect of the present disclosure, the two gear members (250, 250a, 250b, 250V, 250c, 250d) respective may have connection holes (250h, 250ha, 250hb, 250hc, 250hd) formed to allow the two gear members (250, 250a, 250b, 250V, 250c, 250d) to rotate in opposite directions to each other around an axial center, and are coupled with each other via a coupling member (252) that is inserted in the connection holes (250h, 250ha, 250hb, 250hc, 250hd) in a state that the gear teeth (25t, 25ta, 25tb, 25Vt, 25tc, 25td) of the two gear members (250, 250a, 250b, 250V, 250c, 250d) are shifted to each other in the circumferential direction. In this case, the connection hole (250h, 250ha, 250hb, 250hc, 250hd) may be either an elliptical hole or an elongated hole.

In the damper device according to the above aspect of the present disclosure, the movement of the ring gear (25, 25V) in the axial direction may be restricted by the plurality of pinion gears (23, 23V). The relative velocity of the ring gear to the pinion gear is lower than the relative velocity of the ring gear to the carrier. The configuration of restricting the movement in the axial direction of the ring gear by means of the plurality of pinion gears effectively reduces the loss of the rotating inertia mass damper, compared with a configuration of restricting the movement in the axial direction of the ring gear by means of, for example, a member serving as the carrier of the planetary gear.

In the damper device according to the above aspect of the present disclosure, the ring gear (25) may include the two gear members (250, 250a, 250b) and two inertia members (251, 251a, 251b) that are placed across the two gears (250, 250a, 250b) in the axial direction. In this case, the two inertia members (251, 251a, 251b) may be respectively protruded to inner sides of the two gear members (250, 250a, 250b) in a radial direction of the damper device (10) to be opposed to at least part of a side surface of gear teeth (23t) of the pinion gear (23). This configuration enables the pinion gear to restrict the movement in the axial direction of the ring gear in the vicinity of an engagement position of the ring gear and the pinion gear (gear teeth of the ring gear and gear teeth of the pinion gear) where the relative velocity of the ring gear to the pinion gear becomes approximately equal to zero. This extremely effectively reduces the hysteresis of the rotating inertia mass damper.

In the damper device according to the above aspect of the present disclosure, the ring gear (25V) may include the two gear members (250V, 250c, 250d) and an inertia member (251V) that is placed between the two gear members (250V, 250c, 250d). In this case, the pinion gear (23V) may include a large diameter portion (230a) that is engaged with the sun gear (15, 15t) and two small diameter portions (230b) that are protruded on respective sides in the axial direction of the large diameter portion (230a), that have smaller diameters than the large diameter portion (230a), and that are engaged with the two gear members (250V, 250c, 250d) of the ring gear (25V). The two gear members (250V, 250c, 250d) of the ring gear (25V) may be protruded to an inner side of the inertia member (251) in a radial direction of the damper device (10) to be opposed to at least part of a side surface of gear teeth (23ta) of the large diameter portion (230a) of the pinion gear (23V). This configuration enables the pinion gear to restrict the movement in the axial direction of the ring gear in the vicinity of an engagement position of the ring gear and the pinion gear (gear teeth of the ring gear and gear teeth of the pinion gear) where the relative velocity of the ring gear to the pinion gear becomes approximately equal to zero. This extremely effectively reduces the hysteresis of the rotating inertia mass damper.

In the damper device according to the above aspect of the present disclosure, the sun gear (15, 15t, 15Y, 15Z) may rotate integrally with the first rotational element. The carrier (11, 111, 112) may rotate integrally with the second rotational element, and the ring gear (25, 25V) may serve as the mass body (25, 25V).

In the damper device according to the above aspect of the present disclosure, the plurality of rotational elements may include an intermediate element (12, 12X, 12Y). The elastic body (SP1, SP2) may include a first elastic body (SP1) configured to transmit a torque between the input element (11, 11Y) and the intermediate element (12, 12X, 12Y) and a second elastic body (SP2) configured to transmit a torque between the intermediate element (12, 12X, 12Y) and the output element (15, 15X, 15Y). The first rotational element may be one of the input element (11, 11Y) and the output element (15, 15X, 15Y), and the second rotational element may be the other of the input element (11, 11Y) and the output element (15, 15X, 15Y). In the damper device of this aspect, two resonances occur in the torque transmission path configured by the intermediate element and the first and the second elastic bodies when deflections of all the first and second elastic bodies are allowed. This configuration accordingly enables two antiresonance points to be set in the damper device of this aspect. The vibration damping performance of the damper device is extremely effectively improved by making the frequencies of the two antiresonance points equal to (closer to) the frequency of a vibration (resonance) that is to be damped by the damper device. Additionally, the configuration of setting two antiresonance points enables an antiresonance point having the minimum frequency among a plurality of antiresonance points to be shifted to the lower frequency side and improves the vibration damping performance in a wider rotation speed range.

In this case, the input element (11, 11Y) may include two input plate members (111, 112) that are opposed to each other along the axial direction, that are configured to support the plurality of pinion gears (23, 23V) in a rotatable manner and that serve as the carrier. The output element (15, 15X, 15Y) may include one output plate member that is placed between the two input plate members (111, 112) in the axial direction, that includes gear teeth (15t) on an outer circumference thereof and that serves as the sun gear. The intermediate element (12, 12X, 12Y) may include two intermediate plate members (121, 122) that are placed across the two input plate members (111, 112) in the axial direction. This configuration effectively suppresses an increase in axial length of the damper device by placement of the rotating inertia mass damper and the intermediate element.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is preferably applicable to the manufacturing industries of the damper device and so on.

1. A damper device, comprising:
a plurality of rotational elements including an input element which a torque from an engine is transmitted to and an output element;
an elastic body configured to transmit a torque between the input element and the output element; and
a rotating inertia mass damper comprising a mass body; and a planetary gear configured to rotate the mass body with relative rotation of a first rotational element that is one of the plurality of rotational elements to a second rotational element that is different from the first rotational element, wherein
the planetary gear includes a sun gear; a plurality of pinion gears configured to engage with the sun gear; a carrier configured to support the plurality of pinion gears in a rotatable manner; and a ring gear configured to engage with the plurality of pinion gears, wherein
at least one of the sun gear, the pinion gear and the ring gear has two gear members that are arranged along an axial direction of the planetary gear and that are coupled with each other, and
gear teeth of the two gear members are shifted to each other in a circumferential direction of the two gear members, such as to reduce a backlash between the gear teeth of the two gear members and gear teeth of a gear engaging with the two gear members.

2. The damper device according to claim 1,
wherein the two gear members respective have connection holes formed to allow the two gear members to rotate in opposite directions to each other around an axial center, and are coupled with each other via a coupling member that is inserted in the connection holes in a state that the gear teeth of the two gear members are shifted to each other in the circumferential direction.

3. The damper device according to claim 2,
wherein the connection hole is either an elliptical hole or an elongated hole.

4. The damper device according to claim 1,
wherein movement of the ring gear in the axial direction is restricted by the plurality of pinion gears.

5. The damper device according to claim 1,
wherein the ring gear includes the two gear members and two inertia members that are placed across the two gears in the axial direction.

6. The damper device according to claim 5,
wherein the two inertia members are respectively protruded to inner sides of the two gear members in a radial direction of the damper device to be opposed to at least part of a side surface of gear teeth of the pinion gear.

7. The damper device according to claim 1,
wherein the ring gear includes the two gear members and an inertia member that is placed between the two gear members.

8. The damper device according to claim 7,
wherein the pinion gear includes a large diameter portion that is engaged with the sun gear; and two small diameter portions that are protruded on respective sides in the axial direction of the large diameter portion, that have smaller diameters than the large diameter portion, and that are engaged with the two gear members of the ring gear, and
the two gear members of the ring gear are protruded to an inner side of the inertia member in a radial direction of the damper device to be opposed to at least part of a side surface of gear teeth of the large diameter portion of the pinion gear.

9. The damper device according to claim 1,
wherein the sun gear rotates integrally with the first rotational element,
the carrier rotates integrally with the second rotational element, and
the ring gear serves as the mass body.

10. The damper device according to claim 1,
wherein the plurality of rotational elements include an intermediate element,
the elastic body includes a first elastic body configured to transmit a torque between the input element and the intermediate element and a second elastic body configured to transmit a torque between the intermediate element and the output element,
the first rotational element is one of the input element and the output element, and
the second rotational element is the other of the input element and the output element.

11. The damper device according to claim 10,
wherein the input element comprises two input plate members that are opposed to each other along the axial direction, that are configured to support the plurality of pinion gears in a rotatable manner and that serve as the carrier,
the output element comprises one output plate member that is placed between the two input plate members in the axial direction, that includes gear teeth on an outer circumference thereof and that serves as the sun gear, and
the intermediate element comprises two intermediate plate members that are placed across the two input plate members in the axial direction.
